(19) United States
(12) Patent Application Publication
(10) Pub. No.: US 2026/0021615 A1
(43) Pub. Date: Jan. 22, 2026

(54) COATING COMPOSITION AND IN-MOLD COATING METHOD

(71) Applicant: KANSAI PAINT CO., LTD., Hyogo (JP)

(72) Inventors: Haruka Nakaoka, Hiratsuka-shi, Kanagawa (JP); Katsuto Komura, Hiratsuka-shi, Kanagawa (JP)

(21) Appl. No.: 18/997,496

(22) PCT Filed: May 11, 2023
(86) PCT No.: PCT/JP2023/017732

§ 371 Date: Jan. 21, 2025

(30) Foreign Application Priority Data
Jul. 22, 2022 (JP) 2022-116863

(51) Int. Cl. B29C 45/16; B29C 33/58; B29C 33/62; C08G 18/78; C08K 5/20; C09D 7/63; C09D 175/00

(52) U.S. Cl. CPC B29C 45/1679; B29C 33/58; B29C 33/62; C08G 18/7881; C09D 7/63; C09D 175/00; C08K 5/20

(57) ABSTRACT

The purpose of the present invention is to provide a coating composition that has a low VOC content and can form a coating film having an excellent water-resistant adhesiveness, hardness, and weather resistance. The coating composition is characterized by comprising (A) an isocyanate reactive group-containing compound, (B) a polyisocyanate compound, and (C) a carbodiimide group-containing compound, and having a solids concentration of at least 90 mass %. In this coating composition, the carbodiimide group-containing compound (C) has an isocyanate group. Also in this coating composition, the carbodiimide group-containing compound (C) has an aromatic ring structure.

### FIELD

The present invention relates to a coating composition and an in-mold coating method.

### BACKGROUND

Conventionally, for the purpose of imparting excellent appearance and performance to a substrate surface, a coating composition is applied to the substrate surface and the formed wet coating film is cured to form a coating film. In recent years, from the viewpoint of reducing environmental burden, there has been a demand for a reduction in volatile organic compounds (VOCs) in coating compositions and a reduction in air-conditioning energy during coating.

Also in recent years, there has been a demand in various technical fields for high hardness on coating surfaces of substrates and high adhesion between a coating film and a substrate, particularly adhesion after being subjected to water loading (water-resistant adhesion). When the above coating composition is applied to an article to be used outdoors, it is generally required that a coating film having high weather resistance can be formed.

PTL 1 describes that a two-component coating composition comprising a paint base component A and a curing component B, wherein the paint base component A is: i. one or more polyols A1 selected from the group of polyols containing ester groups, and having a hydroxyl number of 300 to 500 mg KOH/g and a hydroxyl group functionality greater than 2; ii. one or more aliphatic polyols A2 free of ether groups and ester groups, of a general formula (I): R¹—(OH)ₚ (wherein R¹ is a p-valent branched, cyclic or linear, saturated or unsaturated, aliphatic hydrocarbon radical having 5 to 18 carbon atoms, the radical R¹ optionally comprising one or more tertiary amino groups, and p is 2 to 6); iii. one or more species A3 of a general formula (II): R²—(C═O)ᵣ—O—(AO)ₛ—R³ (wherein R² is a saturated or unsaturated, aliphatic hydrocarbon radical having 6 to 30 carbon atoms, R³ is H, a radical PO(OH)², or an optionally partially phosphated radical of a mono- or di-saccharide or an optionally partially phosphated radical of an alditol, AO represents one or more alkylene oxide radicals selected from the group consisting of ethylene oxide, propylene oxide, and butylene oxide, r is 0 or 1, and s is 0 to 30); iv. one or more crosslinking catalysts A4 selected from the group of organotin compounds; v. optionally one or more polyamines A5 having at least two secondary amino groups and an amine number of 120 to 280 mg KOH/g; and ix. optionally one or more additives A9 selected from the group consisting of wetting and/or dispersing agents, rheological aids, and flow control agents, and wherein the curing component B comprises: i. one or more polyisocyanates B1 having on average 2.4 to 5 NCO groups; wherein the two-component coating composition has a solid content of at least 96 mass % based on the total mass of the two-component coating composition according to ASTM D2369 (2015); and wherein a molar ratio of the NCO groups in the curing component B to acidic hydrogen atoms of the hydroxyl groups, primary amino groups, and secondary amino groups in the paint base component A is from 1:1.15 to 1:0.95, allows damage-free demolding from normally metal mold surfaces without use of an external release agent, while ensuring superior adhesion to the substrate, and allows for recoating with further coating films, for example, base coats and clear coats, whereby surfaces of superior quality can be formed without costly and inconvenient cleaning and/or polishing steps.

### CITATION LIST

### Patent Literature

[PTL 1] Japanese Unexamined Publication No. 2020-528103

### SUMMARY

### Technical Problem

In the technique described in Reference 1, although the VOC content in the resulting coating composition is low, water-resistant adhesion, hardness, and weather resistance of the coating film to be formed may be insufficient.

The present invention has an object of providing a coating composition capable of forming a coating film having excellent water-resistant adhesion, hardness, and weather resistance and having a low VOC content.

### Solution to Problem

The present inventors have conducted intensive studies to achieve the above object, and as a result, have discovered that the above object can be achieved by a coating composition comprising an isocyanate-reactive group-containing compound (A), a polyisocyanate compound (B), and a carbodiimide group-containing compound (C) and having a solid content concentration of 90 mass % or greater.

Specifically, the present invention relates to <1> to <7> below.
<1> A coating composition, comprising (A) an isocyanate-reactive group-containing compound, (B) a polyisocyanate compound, and (C) a carbodiimide group-containing compound and having a solid content concentration of 90 mass % or greater.
<2> The coating composition according to <1>, wherein the above carbodiimide group-containing compound (C) has an isocyanate group.
<3> The coating composition according to <1> or <2>, wherein the above carbodiimide group-containing compound (C) has an aromatic ring structure.
<4> The coating composition according to any one of <1> to <3>, wherein a number average molecular weight of the above carbodiimide group-containing compound is within a range of 500 to 5000.
<5> An in-mold coating method comprising a step of injecting an in-mold coating composition between a molded substrate and an inner wall of a mold, curing the in-mold coating composition, and then removing a coated molding from a mold, wherein the above in-mold coating composition is the coating composition according to any one of <1> to <4>.
<6> The in-mold coating method according to <5>, wherein the above in-mold coating composition further comprises an internal release agent (D).
<7> The in-mold coating method according to <6>, wherein the above internal release agent (D) comprises a fatty acid amide.

### Advantageous Effects of Invention

According to the present invention, a coating composition capable of forming a coating film having excellent water-resistant adhesion, hardness, and weather resistance and having a low VOC content can be provided.

### DESCRIPTION OF EMBODIMENTS

Hereinafter, the present invention will be described in detail. However, the following merely shows one example of desired embodiments, and the present invention is not limited to the content thereof.

### [Coating Composition]

The coating composition of the present invention is a coating composition comprising an isocyanate-reactive group-containing compound (A), a polyisocyanate compound (B), and a carbodiimide group-containing compound (C) and having a solid content concentration of 90 mass % or greater.

In the present specification, “solid content” means a non-volatile component of a resin, curing agent, or pigment that remains after drying at 80° C. for 30 min. The above solid content, for example, can be determined by weighing a sample in a heat-resistant container such as an aluminum foil cup, spreading the sample on the container bottom surface, then drying the sample at 80° C. at 30 min, and weighing the mass of the component that remains after drying.

In the present specification, “solid content concentration” means a mass content ratio of the above solid content in the composition. Therefore, the solid content concentration of the composition, for example, can be calculated by weighing 1.0 g of composition in a heat-resistant container such as an aluminum foil cup, spreading the composition on the container bottom surface, then drying the composition at 80° C. for 30 min, and weighing the mass of the component in the composition that remains after drying to determine the mass of the component that remains after drying relative to the total mass of the composition before drying.

The solid content concentration in the coating composition of the present invention is 90 mass % or greater. By having a solid content concentration at 90 mass % or greater, VOC content in the resulting coating composition can be decreased. The solid content concentration of the coating composition of the present invention, from the viewpoints of a decrease in VOC content in the resulting coating composition and pinhole resistance of the coating film to be formed, is preferably within the range of 95 to 100 mass %, more preferably within the range of 97 to 100 mass %, and even more preferably within the range of 99 to 100 mass %.

### [Isocyanate-Reactive Group Containing Compound (A)]

The isocyanate-reactive group-containing compound (A) is a compound having at least one isocyanate-reactive group per molecule. The above isocyanate-reactive group is not particularly limited as long as the group is reactive to an isocyanate group. Examples of the isocyanate-reactive group include a hydroxyl group, an amino group, and a thiol group. From the viewpoints of water-resistant adhesion, hardness, and weather resistance of the coating film to be formed, the isocyanate-reactive group preferably comprises at least one selected from a hydroxyl group and an amino group and more preferably comprises a hydroxyl group. Therefore, the above isocyanate-reactive group-containing compound (A) includes a hydroxyl group-containing compound (A1), an amino group-containing compound (A2), and a thiol group-containing compound (A3), and preferably comprises at least one compound selected from a hydroxyl group-containing compound (A1) and an amino group-containing compound (A2), more preferably comprises a hydroxyl group-containing compound (A1).

### [Hydroxyl Group-Containing Compound (A1)]

The above hydroxyl group-containing compound (A1) is a compound having at least one hydroxyl group per molecule. The hydroxyl group-containing compound (A1) includes hydroxyl group-containing oligomers and hydroxyl group-containing polymers, and for example, includes hydroxyl group-containing polyester resins, hydroxyl group-containing polycaprolactone resins, hydroxyl group-containing polyether resins, hydroxyl group-containing polycarbonate resins, hydroxyl group-containing acrylic resins, hydroxyl group-containing acrylic modified polyester resins, hydroxyl group-containing polyurethane resins, hydroxyl group-containing epoxy resins, and hydroxyl group-containing alkyd resins. Among these, from the viewpoints of a decrease in VOC content in the resulting coating composition and water-resistant adhesion, hardness, and weather resistance of the coating film to be formed, it is preferable that hydroxyl group-containing polyester resins be contained. These can each be used independently or in combination of two or more. The above hydroxyl group-containing polyester resin generally can be produced by an esterification reaction or a transesterification reaction between an acid component and an alcohol component.

As the above acid compound, a compound commonly used as a polycarboxylic acid can be used in the production of the above hydroxyl group-containing polyester resin. Examples of such a polycarboxylic acid can include aliphatic polybasic acids, alicyclic polybasic acids, and aromatic polybasic acids.

The above aliphatic polybasic acid, generally, is an aliphatic compound having two or more carboxyl groups per molecule, an acid anhydride of the aliphatic compound, or an ester of the aliphatic compound. Examples of the aliphatic polybasic acid include aliphatic polyvalent carboxylic acids such as succinic acid, glutaric acid, adipic acid, pimelic acid, suberic acid, azelaic acid, sebacic acid, undecanedioic acid, dodecanedioic acid, brassylic acid, octadecanedioic acid, citric acid, and butanetetracarboxylic acid; anhydrides of the aliphatic polyvalent carboxylic acids; and lower alkyl esters of the aliphatic polyvalent carboxylic acids having 1 to 6, preferably 1 to 4, carbon atoms. The above aliphatic polybasic acids can each be used independently or in combination of two or more.

The above alicyclic polybasic acid, generally, is a compound having one or more alicyclic structures and two or more carboxyl groups per molecule, an acid anhydride of the compound, or esters of the compound. The alicyclic structure can be mainly a four- to six-membered ring structure. Examples of the alicyclic polybasic acid include alicyclic polyvalent carboxylic acids such as 1,2-cyclohexanedicarboxylic acid, 1,3-cyclohexanedicarboxylic acid, 1,4-cyclohexanedicarboxylic acid, 4-cyclohexene-1,2-dicarboxylic acid, 3-methyl-1,2-cyclohexanedicarboxylic acid, 4-methyl-1,2-cyclohexanedicarboxylic acid, 1,2,4-cyclohexanetricarboxylic acid, and 1,3,5-cyclohexanetricarboxylic acid; anhydrides of the alicyclic polyvalent carboxylic acids; and lower alkyl esters of the alicyclic polyvalent carboxylic acids having 1 to 6, preferably 1 to 4, carbon atoms. The above alicyclic polybasic acids can each be used independently or in combination of two or more.

The above aromatic polybasic acid is generally an aromatic compound having two or more carboxyl groups per molecule, an acid anhydride of the aromatic compound, or an ester of the aromatic compound. Examples of the aromatic polybasic acid include aromatic polyvalent carboxylic acids such as phthalic acid, isophthalic acid, terephthalic acid, naphthalenedicarboxylic acid, 4,4′-biphenyldicarboxylic acid, trimellitic acid, and pyromellitic acid; anhydrides of the aromatic polyvalent carboxylic acids; and lower alkyl esters of the aromatic polyvalent carboxylic acid having 1 to 6, preferably 1 to 4, carbon atoms. The above aromatic polybasic acids can each be used independently or in combination of two or more.

Acid components other than the above aliphatic polybasic acids, alicyclic polybasic acids, and aromatic polybasic acids can also be used. Such acid components are not particularly limited, and examples include fatty acids such as coconut oil fatty acid, cottonseed oil fatty acid, hempseed oil fatty acid, rice bran oil fatty acid, fish oil fatty acid, tall oil fatty acid, soybean oil fatty acid, linseed oil fatty acid, tung oil fatty acid, rapeseed oil fatty acid, castor oil fatty acid, dehydrated castor oil fatty acid, and safflower oil fatty acid; monocarboxylic acids such as isononanoic acid, neodecanoic acid, lauric acid, myristic acid, palmitic acid, stearic acid, oleic acid, linoleic acid, linolenic acid, benzoic acid, p-tert-butylbenzoic acid, cyclohexanoic acid, and 10-phenyloctadecanoic acid; and hydroxycarboxylic acids such as lactic acid, 3-hydroxybutanoic acid, and 3-hydroxy-4-ethoxybenzoic acid. These acid components can each be used independently or in combination of two or more.

As the above alcohol component, a polyhydric alcohol having 2 or more hydroxyl groups per molecule can be suitably used. Examples of the polyhydric alcohol include dihydric alcohols such as ethylene glycol, propylene glycol, diethylene glycol, trimethylene glycol, tetraethylene glycol, triethylene glycol, dipropylene glycol, 1,4-butanediol, 1,3-butanediol, 2,3-butanediol, 1,2-butanediol, 2-methyl-1,3-propanediol, 3-methyl-1,2-butanediol, 2-butyl-2-ethyl-1,3-propanediol, 1,2-pentanediol, 1,5-pentanediol, 1,4-pentanediol, 2,4-pentanediol, 2,3-dimethyltrimethylene glycol, tetramethylene glycol, 3-methyl-4,3-pentanediol, 3-methyl-1,5-pentanediol, 2,2,4-trimethyl-1,3-pentanediol, 1,6-hexanediol, 1,5-hexanediol, 1,4-hexanediol, 2,5-hexanediol, neopentyl glycol, 1,4-cyclohexanedimethanol, tricyclodecane dimethanol, hydroxypivalic acid neopentyl glycol ester, hydrogenated bisphenol A, hydrogenated bisphenol F, and dimethylolpropionic acid; polylactone diols obtained by adding a lactone compound such as r-caprolactone to the above dihydric alcohols; ester diol compounds such as bis(hydroxyethyl)terephthalate; polyether diol compounds such as alkylene oxide adducts of bisphenol A, polyethylene glycol, polypropylene glycol, and polytetramethylene glycol; trihydric or higher alcohols such as glycerin, trimethylolethane, trimethylolpropane, diglycerin, triglycerin, 1,2,6-hexanetriol, pentaerythritol, dipentaerythritol, tris(2-hydroxyethyl)isocyanuric acid, sorbitol, and mannite; polylactone polyol compounds obtained by adding a lactone compound such as s-caprolactone to the above trihydric or higher alcohols; and fatty acid esters of glycerin.

Alcohol components other than the above polyhydric alcohols can be used. Such alcohol compounds are not particularly limited, and examples include monoalcohols such as methanol, ethanol, propyl alcohol, butyl alcohol, isobutyl alcohol, pentyl alcohol, 2-ethylhexyl alcohol, stearyl alcohol, benzyl alcohol, phenetyl alcohol, and 2-phenoxyethanol; and alcohol compounds obtained by reacting a monoepoxy compound with an acid, such as propylene oxide, butylene oxide, and “Cardura E10P” (trade name, manufactured by Hexion Inc., glycidyl ester of synthetic highly branched saturated fatty acid).

The production method of the above hydroxyl group-containing polyester resin is not particularly limited, and can be carried out by following a conventional method. For example, the hydroxyl group-containing polyester polyol resin can be produced by a method of heating the above acid component and the above alcohol component in a nitrogen gas flow at about 150 to 250° C. for about 5 to 10 h and subjecting the acid component and the alcohol component to an esterification reaction or transesterification reaction.

When the above acid component and the above alcohol component are subjected to an esterification reaction or a transesterification reaction, these components may be added into a reaction at once, or one or both thereof may be added in a plurality of portions. The above hydroxy-containing polyester resin may first be synthesized, and then the resulting hydroxyl group-containing polyester resin may be reacted with an acid anhydride for half-esterification to form a carboxyl group- and hydroxyl group-containing polyester resin. The carboxyl group-containing polyester resin may be synthesized, and then the above alcohol component may be added to produce the hydroxyl group-containing polyester resin.

In the above esterification or transesterification reaction, a catalyst known per se, such as dibutyltin oxide, antimony trioxide, zinc acetate, manganese acetate, cobalt acetate, calcium acetate, lead acetate, tetrabutyl titanate, or tetraisopropyl titanate, can be used as a catalyst for promoting the reaction.

The above hydroxyl group-containing polyester resin can be modified with a fatty acid, a monoepoxy compound, or a polyisocyanate compound during or after production of the resin.

Examples of the above fatty acid include coconut oil fatty acid, cottonseed oil fatty acid, hempseed oil fatty acid, rice bran oil fatty acid, fish oil fatty acid, tall oil fatty acid, soybean oil fatty acid, linseed oil fatty acid, tung oil fatty acid, rapeseed oil fatty acid, castor oil fatty acid, dehydrated castor oil fatty acid, and safflower oil fatty acid. As the above monoepoxy compound, for example, “Cardura E10P” (trade name, manufactured by Hexion Inc., glycidyl ester of synthetic highly branched saturated fatty acid) can be suitably used.

Examples of the polyisocyanate compound include aliphatic diisocyanate compounds such as lysine diisocyanate, hexamethylene diisocyanate, and trimethylhexane diisocyanate; alicyclic diisocyanate compounds such as hydrogenated xylylene diisocyanate, isophorone diisocyanate, methylcyclohexane-2,4-diisocyanate, methylcyclohexane-2,6-diisocyanate, 4,4′-methylenebis(cyclohexylisocyanate), 1,3-(isocyanatomethyl)cyclohexane, and 1,4-(isocyanatomethyl)cyclohexane; aromatic diisocyanate compounds such as tolylene diisocyanate, xylylene diisocyanate, tetramethylxylylene diisocyanate, and diphenylmethane diisocyanate; organic polyisocyanates themselves such as trivalent or higher polyisocyanates, such as lysine triisocyanate and 4-(isocyanatomethyl)octamethylene diisocyanate; adducts of these organic polyisocyanates with polyhydric alcohols, low molecular weight polyester resins, or water; and cyclic polymers and biuret adducts of these organic polyisocyanates (for example, isocyanurates). These polyisocyanate compounds can be used independently or in combination of two or more.

The hydroxyl value of the above hydroxyl group-containing polyester, from the viewpoints of water-resistant adhesion and hardness of the coating film to be formed, is preferably within the range of 1 to 600 mgKOH/g, more preferably within the range of 100 to 580 mgKOH/g, and even more preferably within the range of 300 to 560 mgKOH/g.

The number average molecular weight of the above hydroxyl group-containing polyester resin, from the viewpoints of a decrease in VOC content in the resulting coating composition and water-resistant adhesion of the coating film to be formed, is preferably within the range of 200 to 10,000, more preferably within the range of 250 to 5,000, and even more preferably within the range of 300 to 2,500.

The glass transition temperature (Tg) of the above hydroxyl group-containing polyester resin, from the viewpoints of water-resistant adhesion, hardness, and weather resistance of the coating film to be formed, is preferably within the range of −80 to 10° C., more preferably within the range of −70 to 5° C., and even more preferably within the range of −60 to 0° C.

In the present specification, the number average molecular weight and the weight average molecular weight are values determined by converting the retention time (retention capacity) measured using gel permeation chromatography (GPC) into molecular weight of polystyrene by the retention time (retention capacity) of a standard polystyrene with a known molecular weight measured under the same conditions. Specifically, a “HLC-8120GPC” (trade name, manufactured by Tosoh Corporation) is used as the gel permeation chromatography apparatus; “TSKgel G4000HXL”, “TSKgel G3000HXL”, “TSKgel G2500HXL”, and “TSKgel G2000HXL” (trade names, all manufactured by Tosoh Corporation), four in total, are used as columns; a differential refractometer is used as the detector, and measurements can be carried out under the following conditions of mobile phase: tetrahydrofuran, measurement temperature: 40° C., and flow rate: 1 mL/min.

The glass transition temperature can be measured, for example, by using a differential scanning calorimeter “Model DSC-50Q” (manufactured by Shimadzu Corporation, trade name), placing a sample in a measuring cup, completely removing the solvent by vacuum suction, followed by measuring the change in amount of heat in the range of −100° C. to 150° C. at a heating rate of 3° C./min, and taking the first change-point in the baseline on the low temperature side as the static glass transition temperature.

When the above hydroxyl group-containing compound (A1) comprises a hydroxyl group-containing polyester resin, the content of the hydroxyl group-containing polyester resin, from the viewpoints of water-resistant adhesion and hardness of the coating film to be formed, is preferably within the range of 50 to 100 mass %, more preferably within the range of 60 to 100 mass %, and even more preferably within the range of 75 to 100 mass %, based on the total solid content of the hydroxyl group-containing compound (A1).

The above hydroxyl group-containing polycaprolactone resin can be obtained, for example, by subjecting r-caprolactone to ring-opening polymerization using a dihydric to tetrahydric polyhydric alcohol as an initiator. Examples of the dihydric or higher polyhydric alcohol include polyhydric alcohol compounds obtained by reacting ethylene glycol, glycerin, trimethylolethane, trimethylolpropane, diglycerin, ditrimethylolpropane, 1,2,6-hexanetriol, pentaerythritol, tris(2-hydroxyethyl) isocyanurate, or dimethylolalkanoic acid with a monoepoxy compound (for example, “Cardura E10P; glycidyl ester of synthetic highly branched saturated fatty acid” manufactured by Hexion Specialty Chemicals B.V.). These can be used independently or in combination of two or more.

Commercially available products can be used as the hydroxyl group-containing polycaprolactone resin. Examples of commercially available products can include “Placcel 205”, “Placcel 205H”, “Placcel L205AL”, “Placcel 205U”, “Placcel 208”, “Placcel 210”, “Placcel 210N”, “Placcel 210CP”, “Placcel 212”, “Placcel L212AL”, “Placcel 220”, “Placcel 220N”, “Placcel 220CPB”, “Placcel 220CPT”, “Placcel 220UA”, “Placcel 220NP1”, “Placcel L220AL”, “Placcel 220EB”, “Placcel 230”, “Placcel 230N”, “Placcel 240”, “Placcel 303”, “Placcel 305”, “Placcel 308”, “Placcel 309”, “Placcel 312”, “Placcel 320”, “Placcel L320AL”, “Placcel 410” (all trade names, manufactured by Daicel Corporation), “TONE 0201”, “TONE 0230”, “TONE 0249”, “TONE 0301”, “TONE 0305”, “TONE 0310”, “TONE 1241”, “TONE 1278”, “TONE 2221” (all trade names, manufactured by The Dow Chemical Company), “Capa 2043”, “Capa 2101”, “Capa 2201”, “Capa 2205”, “Capa 2209”, “Capa 2201A”, “Capa 2203A”, “Capa 7201A”, “Capa 7203”, “Capa 3031”, “Capa 3050J”, “Capa 3091”, and “Capa 4101” (all trade names, manufactured by Ingevity).

The hydroxyl value of the above hydroxyl group-containing polycaprolactone resin, from the viewpoints of water-resistant adhesion and hardness of the coating film to be formed, is preferably within the range of 50 to 900 mgKOH/g, more preferably within the range of 100 to 750 mgKOH/g, and even more preferably within the range of 130 to 600 mgKOH/g.

The number average molecular weight of the above hydroxyl group-containing polycaprolactone resin, from the viewpoints of a decrease in VOC content in the resulting coating composition and water-resistant adhesion and hardness of the coating film to be formed, is preferably within the range of 200 to 5000, more preferably within the range of 250 to 3000, and even more preferably within the range of 300 to 2000.

When the above hydroxyl group-containing compound (A1) comprises a hydroxyl group-containing polycaprolactone resin, the content of the hydroxyl group-containing polycaprolactone resin, from the viewpoints of water-resistant adhesion and hardness of the coating film to be formed, is preferably within the range of 5 to 100 mass %, more preferably within the range of 10 to 75 mass %, and even more preferably within the range of 10 to 50 mass %, based on the total solid content of the hydroxyl group-containing compound (A1).

As the above hydroxyl group-containing polyester resin, an alkylene oxide adduct of a hydroxyl group-containing monomer described below or a ring-opening (co)polymer of alkylene oxides or cyclic ethers (such as tetrahydrofuran) can be used. Specific examples can include polyethylene glycol, polypropylene glycol, polytetramethylene glycol, (block or random) copolymers of ethylene glycol-propylene glycol, polyhexamethylene glycol, and polyoctamethylene glycol. The above hydroxyl group-containing polyether resins can be used independently or in combination of two or more.

The hydroxyl value of the above hydroxyl group-containing polyether resin, from the viewpoints of water-resistant adhesion and hardness of the coating film to be formed, is preferably within the range of 50 to 600 mgKOH/g, more preferably within the range of 70 to 500 mgKOH/g, and even more preferably within the range of 90 to 400 mgKOH/g.

The number average molecular weight of the above hydroxyl group-containing polyether resin, from the viewpoints of a decrease in VOC content in the resulting coating composition and water-resistant adhesion and hardness of the coating film to be formed, is preferably within the range of 200 to 10000, more preferably within the range of 300 to 5000, and even more preferably within the range of 400 to 3000.

When the above hydroxyl group-containing compound (A1) comprises a hydroxyl group-containing polyether resin, the content of the hydroxyl group-containing polyether resin, from the viewpoints of water-resistant adhesion, hardness, and weather resistance of the coating film to be formed, is preferably within the range of 5 to 100 mass %, more preferably within the range of 10 to 50 mass %, and even more preferably within the range of 10 to 25 mass %, based on total solid content of the hydroxyl group-containing compound (A1).

The above hydroxyl group-containing polycarbonate resin, according to conventional methods, is a compound obtained by subjecting a known polyol component to a polycondensation reaction with a carbonylating agent. The polyol component can include diol components and polyhydric alcohol components such as trihydric or higher alcohols.

Examples of diol components can include linear diols such as 1,3-propanediol, 1,3-butanediol, 1,5-pentanediol, 1,6-hexanediol, 1,7-heptanediol, 1,8-octanediol, 1,9-nonanediol, and 1,10-decanediol; branched diols such as 2-methyl-1,3-propanediol, 3-methyl-1,5-pentanediol, neopentyl glycol, 2-ethyl-1,6-hexanediol, 2,2-diethyl-1,3-propanediol, 2-butyl-2-ethyl-1,3-propanediol, 2-methyl-1,8-octanediol, 2,2,4-trimethyl-1,3-pentadiol, and 2-ethyl-1,3-hexanediol; alicyclic diols such as 1,3-cyclohexanediol, 1,4-cyclohexanediol, 1,4-cyclohexanedimethanol, and 2,2,4,4-tetramethyl-1,3-cyclobutanediol; aromatic diols such as p-xylenediol and p-tetrachloroxylenediol; ether-based diols such as diethylene glycol and dipropylene glycol; and polylactone diols obtained by adding a lactone compound such as s-caprolactone to any of the above diol components. These diol components can be used independently or in combination of two or more.

Examples of trihydric or higher alcohol can include glycerin, trimethylolethane, dimer of trimethylolpropane, pentaerythritol; and polylactone polyols obtained by adding a lactone compound such as s-caprolactone to the above trihydric or higher alcohols. These trihydric or higher alcohols can be used independently or in combination of two or more.

As the above carbonylating agent, any known carbonylating agent can be used. Specific examples can include alkylene carbonates, dialkyl carbonates, diallyl carbonates, and phosgene. These can be used independently or in combination of two or more. Among these, preferable carbonylating agents can include ethylene carbonate, propylene carbonate, dimethyl carbonate, diethyl carbonate, dibutyl carbonate, and diphenyl carbonate.

The hydroxyl value of the above hydroxyl group-containing polycarbonate resin, from the viewpoints of water-resistant adhesion and hardness of the coating film to be formed, is preferably within the range of 50 to 600 mgKOH/g, more preferably within the range of 70 to 500 mgKOH/g, and even more preferably within the range of 90 to 400 mgKOH/g.

The number average molecular weight of the above hydroxyl group-containing polycarbonate resin, from the viewpoints of a decrease in VOC content in the resulting coating composition and water-resistant and hardness of the coating film to be formed, is preferably within the range of 200 to 10000, more preferably within the range of 300 to 5000, and even more preferably within the range of 400 to 3000.

When the above hydroxyl group-containing compound (A1) comprises a hydroxyl group-containing polycarbonate resin, the content of the hydroxyl group-containing polycarbonate resin, from the viewpoints of water-resistant adhesion, hardness, and weather resistance of the coating film to be formed, is preferably within the range of 5 to 100 mass %, more preferably within the range of 10 to 50 mass %, and even more preferably within the range of 10 to 25 mass %, based on the total solid content of the hydroxyl group-containing compound (A1).

The above hydroxyl group-containing acrylic resin can be produced, for example, by copolymerizing a hydroxyl group-containing polymerizable unsaturated monomer and another polymerizable unsaturated monomer that can be copolymerized with the hydroxyl group-containing polymerizable unsaturated monomer, by a method known per se, for example, a solution polymerization method in an organic solvent or an emulsion polymerization method in water.

The above hydroxyl group-containing polymerizable unsaturated monomer is a compound having one or more of each of a hydroxyl group and a polymerizable unsaturated bond per molecule. Examples of the hydroxyl group-containing polymerizable unsaturated monomer can include monoesters of (meth)acrylic acid and dihydric alcohols having 2 to 8 carbon atoms, such as 2-hydroxyethyl (meth)acrylate, 2-hydroxypropyl (meth)acrylate, 3-hydroxypropyl (meth)acrylate, and 4-hydroxybutyl (meth)acrylate; s-caprolactone-modified monoesters of (meth)acrylic acid and dihydric alcohols having 2 to 8 carbon atoms; N-hydroxymethyl (meth)acrylamide; allyl alcohol, and (meth)acrylates having a polyoxyethylene chain wherein a molecular terminal is a hydroxyl group.

In the present invention, monomers corresponding to the polymerizable unsaturated monomer having an ultraviolet-absorbing functional group (xvii) described below should be defined as other polymerizable unsaturated monomers that can be copolymerized with the above hydroxyl group-containing polymerizable unsaturated monomer, and are excluded from the hydroxyl group-containing polymerizable unsaturated monomer. These can be used independently or in combination of two or more.

As other polymerizable unsaturated monomers that can be copolymerized with the above hydroxyl group-containing polymerizable unsaturated monomer, for example, monomers (i) to (xx) below can be used. These polymerizable unsaturated monomers can be used independently or in combination of two or more.
(i) Alkyl or cycloalkyl (meth)acrylate: for example, methyl (meth)acrylate, ethyl (meth)acrylate, n-propyl(meth)acrylate, isopropyl(meth)acrylate, n-butyl(meth)acrylate, isobutyl (meth)acrylate, tert-butyl (meth)acrylate, n-hexyl (meth)acrylate, n-octyl (meth)acrylate, 2-ethylhexyl (meth)acrylate, nonyl (meth)acrylate, tridecyl (meth)acrylate, lauryl (meth)acrylate, stearyl (meth)acrylate, isostearyl (meth)acrylate, cyclohexyl (meth)acrylate, methyl cyclohexyl (meth)acrylate, t-butyl cyclohexyl (meth)acrylate, cyclododecyl (meth)acrylate, and tricyclodecanyl (meth)acrylate
(ii) Polymerizable unsaturated monomers having an isobornyl group: isobornyl (meth)acrylate
(iii) Polymerizable unsaturated monomers having an adamantyl group: adamantyl (meth)acrylate
(iv) Polymerizable unsaturated monomers having a tricyclodecenyl group: tricyclodecenyl (meth)acrylate
(v) Aromatic ring-containing polymerizable unsaturated monomers: benzyl (meth)acrylate, styrene, α-methyl styrene, and vinyl toluene
(vi) Polymerizable unsaturated monomers having an alkoxysilyl group: vinyltrimethoxysilane, vinyltrimethoxysilane, vinyltris(2-methoxyethoxy)silane, γ-(meth)acryloyloxypropyl trimethoxysilane, and γ-(meth)acryloyloxypropyl triethoxysilane
(vii) Polymerizable unsaturated monomers having a fluorinated alkyl group: perfluoroalkyl (meth)acrylates such as perfluorobutylethyl (meth)acrylate and perfluorooctylethyl (meth)acrylate; fluoroolefins
(viii) Polymerizable unsaturated monomers having a photopolymerizable functional group such as a maleimide group
(ix) Vinyl compounds: N-vinylpyrrolidone, ethylene, butadiene, chloroprene, vinyl propionate, and vinyl acetate
(x) Carboxyl group-containing polymerizable unsaturated monomers: (meth)acrylic acid, maleic acid, crotonic acid, and β-carboxyethyl (meth)acrylate
(xi) Nitrogen-containing polymerizable unsaturated monomer: (meth)acrylonitrile, (meth)acrylamide, N,N-dimethylaminoethyl (meth)acrylate, N,N-diethylaminoethyl (meth)acrylate, N,N-dimethylaminopropyl (meth)acrylamide, methylene bis(meth)acrylamide, ethylenebis(meth)acrylamide, and adducts of glycidyl (meth)acrylate and amine compounds
(xii) Polymerizable unsaturated monomers having two or more polymerizable unsaturated groups per molecule: allyl (meth)acrylate, ethylene glycol di(meth)acrylate, 1,4-butanediol di(meth)acrylate, neopentyl glycol di(meth)acrylate, and 1,6-hexanediol di(meth)acrylate
(xiii) Epoxy group-containing polymerizable unsaturated monomers: glycidyl (meth)acrylate, (3-methylglycidyl (meth)acrylate, 3,4-epoxycyclohexylmethyl (meth)acrylate, 3,4-epoxycyclohexylethyl (meth)acrylate, 3,4-epoxycyclohexylpropyl (meth)acrylate, and allyl glycidyl ether
(xiv) (Meth)acrylates having a polyoxyethylene chain wherein a molecular terminal is an alkoxy group
(xv) Polymerizable unsaturated monomers having a sulfonate group: 2-acrylamido-2-methylpropanesulfonic acid, 2-sulfoethyl (meth)acrylate, allylsulfonic acid, 4-styrenesulfonic acid; and sodium salts and ammonium salts of the above sulfonic acids
(xvi) Polymerizable unsaturated monomers having a phosphate group: acid phosphooxyethyl (meth)acrylate, acid phosphooxypropyl (meth)acrylate, acid phosphooxypoly(oxyethylene)glycol (meth)acrylate, and acid phosphooxypoly(oxypropylene)glycol (meth)acrylate
(xvii) Polymerizable unsaturated monomers having an ultraviolet-absorbing functional group: 2-hydroxy-4-(3-methacryloyloxy-2-hydroxypropoxy)benzophenone, 2-hydroxy-4-(3-acryloyloxy-2-hydroxypropoxy)benzophenone, 2,2′-dihydroxy-4-(3-methacryloyloxy-2-hydroxypropoxy)benzophenone, 2,2′-dihydroxy-4-(3-acryloyloxy-2-hydroxypropoxy)benzophenone, and 2-(2′-hydroxy-5′-methacryloyloxyethylphenyl)-2H-benzotriazole
(xviii) Photostable polymerizable unsaturated monomers: 4-(meth)acryloyloxy-1,2,2,6,6-pentamethylpiperidine, 4-(meth)acryloyloxy-2,2,6,6-tetramethylpiperidine, 4-cyano-4-(meth)acryloylamino-2,2,6,6-tetramethylpiperidine, 1-(meth)acryloyl-4-(meth)acryloylamino-2,2,6,6-tetramethylpiperidine, 1-(meth)acryloyl-4-cyano-4-(meth)acryloylamino-2,2,6,6-tetramethylpiperidine, 4-crotonoyloxy-2,2,6,6-tetramethylpiperidine, 4-crotonoylamino-2,2,6,6-tetramethylpiperidine, and 1-crotonoyl-4-crotonoyloxy-2,2,6,6-tetramethylpiperidine
(xix) Polymerizable unsaturated monomers having a carbonyl group: acrolein, diacetone acrylamide, diacetone methacrylamide, acetoacetoxyethyl methacrylate, formyl styrene, and vinyl alkyl ketones having 4 to 7 carbon atoms (for example, vinyl methyl ketone, vinyl ethyl ketone, and vinyl butyl ketone)
(xx) Polymerizable unsaturated monomers having an acid anhydride group: maleic anhydride, itaconic anhydride, and citraconic anhydride

In the present specification, a polymerizable unsaturated group means an unsaturated group that can undergo radical polymerization. Examples of such an unsaturated group include a vinyl group, a (meth)acryloyl group, a (meth)acrylamide group, a vinyl ether group, an allyl group, a propenyl group, an isopropenyl group, and a maleimide group.

In the present specification, “(meth)acrylate” means acrylate or methacrylate. “(Meth)acrylic acid” means acrylic acid or methacrylic acid. “(Meth)acryloyl” means acryloyl or methacryloyl. “(Meth)acrylamide” means acrylamide or methacrylamide.

The hydroxyl value of the above hydroxyl group-containing acrylic resin, from the viewpoints of water-resistant adhesion and hardness of the coating film to be formed, is preferably within the range of 5 to 240 mgKOH/g, more preferably within the range of 20 to 220 mgKOH/g, and even more preferably within the range of 25 to 200 mgKOH/g.

The weight average molecular weight of the above hydroxyl group-containing acrylic resin, from the viewpoints of a decrease in VOC content in the resulting coating composition and water-resistant adhesion of the coating film to be formed, is preferably within the range of 500 to 50,000, more preferably within the range of 1,000 to 30,000, and even more preferably within the range of 1,500 to 10,000.

The glass transition temperature (Tg) of the above hydroxyl group-containing acrylic resin, from the viewpoints of water-resistant adhesion, hardness, and weather resistance of the coating film to be formed, is preferably within the range of −60 to 80° C., more preferably within the range of −50 to 70° C., and even more preferably within the range of −40 to 60° C.

In the present specification, the glass transition temperature (Tg) of the above hydroxyl group-containing acrylic resin is a value calculated by the following formula.

$$\begin{matrix}1 / Tg ( K ) = W 1 / T 1 + W 2 / T 2 + … Wn / Tn \\ Tg ( ° C . ) = Tg ( K ) - 273\end{matrix}$$

where W1, W2, . . . Wn are mass fractions of each monomer; T1, T2 . . . Tn are glass transition temperatures Tg (K) of homopolymers of each monomer.
   The glass transition temperatures of homopolymers of each monomer are values from POLYMER HANDBOOK Fourth Edition, J. Brandrup, E. H. Immergut, E. A. Grulke (Eds.) (1999). Glass transition temperatures of monomers not described in the literature are each defined as a static glass transition temperature when a homopolymer of the monomer is synthesized so as to have a weight average molecular weight of about 50,000.

When the above hydroxyl group-containing compound (A1) comprises a hydroxyl group-containing acrylic resin, the content of the hydroxyl group-containing acrylic resin, from the viewpoints of water-resistant adhesion, hardness, and weather resistance of the coating film to be formed, is preferably within the range of 5 to 100 mass %, more preferably within the range of 10 to 75 mass %, and even more preferably within the range of 15 to 50 mass %, based on the total solid content of the hydroxyl group-containing compound (A1).

Examples of the hydroxyl group-containing compound (A1) include, as hydroxyl group-containing monomers, ethylene glycol, propylene glycol, diethylene glycol, trimethylene glycol, tetraethylene glycol, triethylene glycol, dipropylene glycol, 1,4-butanediol, 1,3-butanediol, 2,3-butanediol, 1,2-butanediol, 2-methyl-1,3-propanediol, 3-methyl-1,2,-butanediol, 2-butyl-2-ethyl-1,3-propanediol, 1,2-pentanediol, 1,5-pentanediol, 1,4-pentanediol, 2,4-pentanediol, 2,3-dimethyltrimethylene glycol, tetramethylene glycol, 3-methyl-4,3-pentanediol, 3-methyl-1,5-pentanediol, 2,2,4-trimethyl-1,3-pentanediol, 1,6-hexanediol, 1,5-hexanediol, 1,4-hexanediol, 2,5-hexanediol, neopentyl glycol, 1,4-cyclohexanedimethanol, tricyclodecane dimethanol, hydroxypivalic acid neopentyl glycol ester, hydrogenated bisphenol A, hydrogenated bisphenol F, glycerin, trimethylolethane, trimethylolpropane, diglycerin, triglycerin, 1,2,6-hexanetriol, pentaerythritol, dipentaerythritol, tris(2-hydroxyethyl) isocyanurate, sorbitol, mannite, hydroxyacetone, 4-(2-hydroxyethyl)morpholine, benzyl alcohol, 2-phenylethanol, 2-phenoxyethanol, naphthalene-1-ol, (1,3-benzoxol-5-yl)methanol, nonylphenol, dinonylphenol, nonylphenol ethoxylate, monostyrenated phenol, distyrenated phenol, and tristyrenated phenol. These can each be used independently or in combination of two or more.

When the above hydroxyl group-containing compound (A1) comprises a hydroxyl group-containing monomer, the content of the hydroxyl group-containing monomer, from the viewpoints of water-resistant adhesion, hardness, and weather resistance of the coating film to be formed, is preferably within the range of 5 to 100 mass %, more preferably within the range of 5 to 50 mass %, and even more preferably within the range of 5 to 30 mass %, based on the total solid content of the hydroxyl group-containing compound (A1).

When the above isocyanate-reactive group-containing compound (A) comprises the above hydroxyl group-containing compound (A1), the content of the hydroxyl group-containing compound (A1), from the viewpoints of water-resistant, hardness, and weather resistance of the coating film to be formed, is preferably within the range of 50 to 100 mass %, more preferably within the range of 60 to 100 mass %, and even more preferably within the range of 70 to 100%, based on the total solid content of the isocyanate-reactive group-containing compound (A).

### [Amino Group-Containing Compound (A2)]

The amino group-containing compound (A2) is a compound having at least one primary amino group and/or secondary amino group per molecule. Examples of the above amino group-containing compound (A2) include aliphatic polyamines such as ethylenediamine, pentamethylenediamine, hexamethylenediamine, trimethylhexamethylenediamine, diethylenetriamine, dipropylenetriamine, triethylenetetramine, N,N′-bis-(3-aminopropyl)ethylenediamine, and tetraethylenepentamine; alicyclic polyamines such as 1,2-cyclohexanediamine, 1,3-cyclohexanediamine, 1,4-cyclohexanediamine, 4-methyl-1,3-cyclohexanediamine, 2-methyl-1,3-cyclohexanediamine, isophoronediamine, 4,4′-methylenebis(cyclohexylamine), 3,3′-dimethyl-4,4′-methylenebis(cyclohexylamine), N,N′-(isophoronediamino)bispropionitrile, N,N′-di-sec-butyl-4,4′-methylenebis(cyclohexylamine), 1,2-bis(aminomethyl)cyclohexane, 1,3-bis(aminomethyl)cyclohexane, 1,4-bis(aminomethyl)cyclohexane, and norbornanediamine; heterocyclic polyamines such as piperazine and N-(2-aminoethyl)piperazine; aromatic polyamines such as 2,4-toluenediamine, 2,6-toluenediamine, 4,4′-diaminodiphenylmethane, diethyltoluenediamine, dimethylthiotoluenediamine, 4,4′-methylenebis[N-(1-methylpropyl)aniline], 4,4′-diaminodiphenyl sulfone, 3,3′-diaminodiphenyl sulfone, 4,4′-diaminodiphenyl ether, 1,3-bis(3-aminophenoxy)benzene, 4,4′-(1,3-phenylenediisopropylidene)bisaniline, 4,4′-(1,4-phenylenediisopropylidene)bisaniline, aminobenzylamine, m-xylylenediamine, p-xylylenediamine, and N,N′-di-sec-butyl-p-phenylenediamine; polyether polyamine compounds such as polyoxypropylene diamine, polyoxyethylene diamine, poly(oxyethylene/oxypropylene) diamine, trimethylolpropane poly(oxypropylene) triamine, and glyceryl poly(oxypropylene) triamine; polyaspartic acid ester compounds such as tetraethyl N,N′-(2-methylpentane-1,5-diyl)bisaspartate, tetraethyl N,N′-[methylenebis(cyclohexane-4,1-diyl)]bisaspartate, tetraethyl N,N′-[methylenebis(2-methylcyclohexane-4,1-diyl)]bisaspartate, and α-{2-[(1,4-diethoxy-1,4-dioxobutan-2-yl)amino]propyl}-ω-{2-[(1,4-diethoxy-1,4-dioxobutan-2-yl)amino]propoxy}poly[oxy(methylethylene)]; and aminosilane compounds such as N-β(aminoethyl)-γ-aminopropyltrimethoxysilane, N—β(aminoethyl)-γ-aminopropylmethyldimethoxysilane, and γ-anilinopropyltrimethoxysilane. These can each be used independently or in combination of two or more.

The above amino group-containing compound (A2), from the viewpoints of a decrease in VOC content in the resulting coating composition and water-resistant adhesion, hardness, and weather resistance of the coating film to be formed, preferably comprises at least one compound selected from aliphatic polyamines, alicyclic polyamines, polyether polyamine compounds, and polyaspartic acid ester compounds, more preferably comprises at least one compound selected from alicyclic polyamines and polyaspartic acid esters, and even more preferably comprises a polyaspartic acid ester compound.

Commercially available products can be used as the above amino group-containing compound (A2). Trade names of commercially available products, for example, include “Baxxodur EC110”, “DETA”, “N4 Amine”, “Baxxodur EC210”, “Baxxodur EC201”, “Baxxodur EC330”, “Baxxodur EC331”, “Baxxodur PC136”, “Baxxodur EC130”, “Baxxodur EC280”, “Baxxodur EC301”, “Baxxodur EC302”, “Baxxodur EC303”, “Baxxodur EC310”, “Baxxodur EC311” (the above are names of products manufactured by BASF SE), “Clearlink 1000”, “Unilink 4200”, “Unilink 4100” (the above are names of products manufactured by Dorf Ketal Chemicals LLC), “JEFFAMINE M-600”, “JEFFAMINE M-1000”, “JEFFAMINE M-2005”, “JEFFAMINE M-2070”, “JEFFAMINE M-3085”, “JEFFAMINE D-230”, “JEFFAMINE D-400”, “JEFFAMINE D-2000”, “JEFFAMINE D-4000”, “JEFFAMINE ED-600”, “JEFFAMINE ED-900”, “JEFFAMINE ED-2003”, “JEFFAMINE EDR-148”, “JEFFAMINE RT-1000”, “JEFFAMINE T-403”, “JEFFAMINE T-3000”, “JEFFAMINE T-5000” (the above are names of products manufactured by Huntsman International LLC), “MXDA”, “1,3-BAC” (the above are names of products manufactured by Mitsubishi Gas Chemical Company, Inc.), “WANAMINE MDA-100H”, “ETHACURE 100 Plus”, “ETHACURE 300”, “ETHACURE 420”, “Bisaniline-M”, “Bisaniline-P” (the above are names of products manufactured by Mitsui Fine Chemicals, Inc.), “VESTAMIN IPD”, “VESTAMIN TMD”, “VESTAMIN PACM”, “ANCAMINE 2049”, “AMICURE IC-321”, “AMICURE IC-322” (the above are names of products manufactured by Evonik Industries), “D.E.H. 20”, “D.E.H. 24”, “D.E.H. 26”, “D.E.H. 29”, “D.E.H. 39”, “D.E.H. 444”, “D.E.H. 445”, “D.E.H. 4042”, “D.E.H. 4044”, “D.E.H. 487”, “D.E.H. 488”, “D.E.H. 530”, “D.E.H.” (the above are names of products manufactured by The Dow Chemical Company), “Desmophen NH1220”, “Desmophen NH1420”, “Desmophen NH1422”, “Desmophen NH1423”, “Desmophen NH1520”, “Desmophen NH1521”, “Desmophen NH1523”, “Desmophen NH1723LF”, “Desmophen NH2885”, “Desmophen NH2886” (the above are names of products manufactured by Covestro AG), “FEISPARTIC F220”, “FEISPARTIC F420”, “FEISPARTIC F520”, “FEISPARTIC F2850”, “FEISPARTIC F2872”, “FEISPARTIC F221”, “FEISPARTIC F321”, “FEISPARTIC F525”, “FEISPARTIC F421”, “FEISPARTIC F524”, “FEISPARTIC F330”, “FEISPARTIC D2925”, “FEISPARTIC D2903” (the above are names of products manufactured by Feiyang Protech Corp.), “TSE-EZASP 7980”, “TSE-EZASP 7981”, “TSE-EZASP 9033”, “TSE-EZASP 8443” (the above are names of products manufactured by TSE Industries), “Altor 200”, “Altor 201”, “Altor 202”, and “Altor 205LV” (the above are names of products manufactured by Cargill, Incorporated).

Commercially available products can be used as the above polyaspartic acid ester compound. Trade names of commercially available products, for example, include “Desmophen NH1220”, “Desmophen NH1420”, “Desmophen NH1422”, “Desmophen NH1423”, “Desmophen NH1520”, “Desmophen NH1521”, “Desmophen NH1523”, “Desmophen NH1723LF”, “Desmophen NH2885”, “Desmophen NH2886” (the above are names of products manufactured by Covestro AG), “FEISPARTIC F220”, “FEISPARTIC F420”, “FEISPARTIC F520”, “FEISPARTIC F2850”, “FEISPARTIC F2872”, “FEISPARTIC F221”, “FEISPARTIC F321”, “FEISPARTIC F525”, “FEISPARTIC F421”, “FEISPARTIC F524”, “FEISPARTIC F330”, “FEISPARTIC D2925”, “FEISPARTIC D2903” (the above are names of products manufactured by Feiyang Protech Corp.), “TSE-EZASP 7980”, “TSE-EZASP 7981”, “TSE-EZASP 9033”, “TSE-EZASP 8443” (the above are names of products manufactured by TSE Industries), “Altor 200”, “Altor 201”, “Altor 202”, and “Altor 205LV” (the above are names of products manufactured by Cargill, Incorporated).

When the above isocyanate-reactive group-containing compound (A) comprises the above amino group-containing compound (A2), the content of the amino group-containing compound (A2), from the viewpoints of water-resistant adhesion, hardness, and weather resistance of the coating film to be formed, is preferably within the range of 5 to 100 mass %, more preferably within the range of 10 to 80 mass %, and even more preferably within the range of 10 to 70 mass %, based on the total solid content of the isocyanate-reactive group-containing compound (A).

### [Thiol Group-Containing Compound (A3)]

The above thiol group-containing compound (A3) is a compound having at least one thiol group per molecule. Examples of the above thiol group-containing compound (A3) can include pentaerythritol tetrakis(3-mercaptopropionate), trimethylolpropane tris(3-mercaptopropionate), tris-[(3-mercaptopropionyloxy)-ethyl]-isocyanurate, tetraethylene glycol bis(3-mercaptopropionate), tetramethylene glycol bis(3-mercaptopropionate), dipentaerythritol hexakis(3-mercaptopropionate), trimethylolpropane dipropanethiol, pentaerythritol tripropanethiol, pentaerythritol tetrapropanethiol, 1,4-bis(mercaptomethyl)benzene, pentaerythritol tetrakis(3-mercaptobutyrate), trimethylolpropane tris(3-mercaptobutyrate), tetramethylene glycol bis(3-mercaptobutyrate), tris-[(3-mercaptobutyroyloxy)-ethyl]-isocyanurate, trimethylolpropane tris(thioglycolate), and pentaerythritol tetrakis(thioglycolate). These can each be used independently or in combination of two or more.

Commercially available products can be used as the above thiol group-containing compound (A3). Trade names of commercially available products, for example, can include “TMMP-LV”, “TEMPIC”, “PEMP-LV”, “DPMP”, “EGMP-4”, “BDMP”, “Multhiol Y-2”, “Multhiol Y-3”, “Multhiol Y-4”, “PXDT” (the above are names of products manufactured by Sakai Chemical Industry Co., Ltd.), “BDTG”, “HDTG”, “TMTG”, “PETG”, “EGTP”, “BDTP”, “TMTP”, “PETP” (the above are names of products manufactured by Yodo Kagaku Co., Ltd.), “Adeka Hardener EH-317” (the above is name of product manufactured by Adeka Corporation), “Karenz MT PEI”, “Karenz MT BDI”, “Karenz MT BD1”, “Karenz MT TPMB”, “Karenz MT NRI” (the above are names of products manufactured by Showa Denko K.K.), “jER Cure QX11”, and “jER Cure QX40” (the above are names of products manufactured by Mitsubishi Chemical Corporation).

When the above isocyanate-reactive group-containing compound (A) comprises the above thiol group-containing compound (A3), the content of the thiol group-containing compound (A3), from the viewpoints of water-resistant adhesion, hardness, and weather resistance of the coating film to be formed, is preferably within the range of 5 to 100 mass %, more preferably within the range of 10 to 50 mass %, and even more preferably within the range of 10 to 30 mass %, based on the total solid content of the isocyanate-reactive group-containing compound (A).

The content of the above isocyanate-reactive group-containing compound (A) in the coating composition of the present invention, from the viewpoints of water-resistant adhesion, hardness, and weather resistance of the coating film to be formed, is preferably within the range of 15 to 80 mass %, more preferably within the range of 20 to 70 mass %, and even more preferably within the range of 25 to 50 mass %, based on the total amount of the coating composition.

### [Polyisocyanate Compound (B)]

The above polyisocyanate compound (B) is a compound having at least two isocyanate groups per molecule, and for example, encompasses aliphatic polyisocyanates, alicyclic polyisocyanates, aromatic aliphatic polyisocyanates, aromatic polyisocyanates, and derivatives of these polyisocyanates.

In the present invention, compounds having a carbodiimide group and two or more isocyanate groups are not included in the above polyisocyanate compound (B) but are included in the carbodiimide group-containing compound (C).

Examples of the above aliphatic polyisocyanate can include aliphatic diisocyanates such as trimethylene diisocyanate, tetramethylene diisocyanate, hexamethylene diisocyanate, pentamethylene diisocyanate, 1,2-propylene diisocyanate, 1,2-butylene diisocyanate, 2,3-butylene diisocyanate, 1,3-butylene diisocyanate, 2,4,4- or 2,2,4-trimethylhexamethylene diisocyanate, dimer acid diisocyanate, and methyl 2,6-diisocyanatohexanoate (common name: lysine diisocyanate); and aliphatic triisocyanates such as 2-isocyanatoethyl 2,6-diisocyanatohexanoate, 1,6-diisocyanato-3-isocyanatomethylhexane, 1,4,8-triisocyanatooctane, 1,6,11-triisocyanatoundecane, 1,8-diisocyanato-4-isocyanatomethyloctane, 1,3,6-triisocyanatohexane, and 2,5,7-trimethyl-1,8-diisocyanato-5-isocyanatomethyloctane.

Examples of the above alicyclic polyisocyanate can include alicyclic diisocyanates such as 1,3-cyclopentene diisocyanate, 1,4-cyclohexane diisocyanate, 1,3-cyclohexane diisocyanate, 3-isocyanatomethyl-3,5,5-trimethylcyclohexyl isocyanate (common name: isophorone diisocyanate), methyl-2,4-cyclohexane diisocyanate, methyl-2,6-cyclohexane diisocyanate, 1,3-or 1,4-bis(isocyanatomethyl)cyclohexane (common name: hydrogenated xylylene diisocyanate) and mixtures thereof, and norbornane diisocyanate; alicyclic triisocyanates such as 1,3,5-triisocyanatocyclohexane, 1,3,5-trimethylisocyanatocyclohexane, 2-(3-isocyanatopropyl)-2,5-di(isocyanatomethyl)-bicyclo(2.2.1)heptane, 2-(3-isocyanatopropyl)-2,6-di(isocyanatomethyl)-bicyclo(2.2.1)heptane, 3-(3-isocyanatopropyl)-2,5-di(isocyanatomethyl)-bicyclo(2.2.1)heptane, 5-(2-isocyanatoethyl)-2-isocyanatomethyl-3-(3-isocyanatopropyl)-bicyclo(2.2.1)heptane, 6-(2-isocyanatoethyl)-2-isocyanatomethyl-3-(3-isocyanatopropyl)-bicyclo(2.2.1)heptane, 5-(2-isocyanatoethyl)-2-isocyanatomethyl-2-(3-isocyanatopropyl)-bicyclo(2.2.1)-heptane, and 6-(2-isocyanatoethyl)-2-isocyanatomethyl-2-(3-isocyanatopropyl)-bicyclo(2.2.1)heptane.

Examples of the above aromatic aliphatic polyisocyanate can include aromatic aliphatic diisocyanates such as 1,3- or 1,4-xylylene diisocyanate and mixtures thereof, ω,ω′-diisocyanato-1,4-diethylbenzene, and 1,3- or 1,4-bis(1-isocyanato-1-methylethyl)benzene (common name: tetramethyl xylylene diisocyanate) and mixtures thereof; and aromatic aliphatic triisocyanates such as 1,3,5-triisocyanatomethylbenzene.

Examples of the above aromatic polyisocyanates can include aromatic diisocyanates such as m-phenylene diisocyanate, p-phenylene diisocyanate, 4,4′-diphenyl diisocyanate, 1,5-naphthalene diisocyanate, 2,4′- or 4,4′-diphneylmethane diisocyanate and mixtures thereof, 2,4- or 2,6-tolylene diisocyanate or mixtures thereof, 4,4′-toluidine diisocyanate, and 4,4′-diphenylether diisocyanate; aromatic triisocyanate such as triphenylmethane-4,4′,4″-triisocyanate, 1,3,5-triisocyanatobenzene, and 2,4,6-triisocyanatotoluene; and aromatic tetraisocyanates such as 4,4′-diphenylmethane-2,2′,5,5′-tetraisocyanate.

Examples of derivatives of the above polyisocyanates can include dimers, trimers, biurets, allophanates, uretdiones, uretonimines, isocyanurates, iminooxadiazinediones, polymethylene polyphenyl polyisocyanates (crude MDI, polymeric MDI), and crude TDI of the polyisocyanate compounds described above.

The above polyisocyanates and derivatives thereof can each be used independently or in combination of two or more. Of these polyisocyanates, aliphatic diisocyanates, aliphatic triisocyanates, alicyclic diisocyanates, and aromatic aliphatic diisocyanates and derivatives thereof can each be suitably used independently or in combination of two or more.

As the above polyisocyanate compound (B), a prepolymer obtained by reacting the above polyisocyanate or a derivative thereof with a compound that can react with the polyisocyanate under the condition of an excess of isocyanate groups may be used. Examples of the compound that can react with the polyisocyanate include compounds having an active hydrogen group such as hydroxyl group or amino group. Specifically, for example, polyhydric alcohol, low molecular weight polyester resin, amine, or water can be used. As the above polyhydric alcohol, a polyhydric alcohol used in the description of the above hydroxyl group-containing polyester resin can be used.

The above polyisocyanate compound (B), from the viewpoints of water-resistant adhesion and hardness of the coating film to be formed, is used in a ratio so that the ratio of isocyanate groups in the polyisocyanate compound (B) relative to isocyanate groups in the above isocyanate-reactive group-containing compound (A) preferably falls within the range of 0.7 to 2.0 and more preferably falls within the range of 0.9 to 1.5.

The content of the above polyisocyanate compound (B) in the coating composition of the present invention, from the viewpoints of water-resistant adhesion, hardness, and weather resistance of the coating film to be formed, is preferably within the range of 10 to 80 mass %, more preferably within the range of 20 to 75 mass %, and even more preferably within the range of 30 to 70 mass %, based on the total amount of the coating composition.

### [Carbodiimide Group-Containing Compound (C)]

The carbodiimide group-containing compound (C) is a compound having at least one carbodiimide group per molecule, and for example, those obtained by subjecting isocyanate groups of an isocyanate group-containing compound to a carbon dioxide removal reaction with each other can be used.

Commercially available products can be used as the above carbodiimide group-containing compound. Trade names of commercially available products can include “Carbodilite V-02B”, “Carbodilite V-05”, “Elastostab H01”, “Carbodilite V-03”, “Carbodilite V-07”, “Carbodilite V-09”, “Carbodilite V-09 GB”, “Carbodilite V-09M”, “Carbodilite VO4PF” (the above are names of products manufactured by Nisshinbo Chemical Inc.), “Stabaxol I”, “Stabaxol I LF”, “Stabaxol P”, “Stabaxol P100”, and “Stabaxol P200” (the above are names of products manufactured by LANXESS).

The carbodiimide group-containing compound (C), from the viewpoints of a decrease in VOC content in the resulting coating composition and pinhole resistance of the coating film to be formed, preferably comprises a solvent-free carbodiimide group-containing compound, and from the viewpoint of water-resistant adhesion of the coating film to be formed, preferably has an isocyanate group and/or an aromatic ring structure.

Commercially available products can be used as the above solvent-free carbodiimide group-containing compound. Trade names of commercially available products can include “Carbodilite V-02B”, “Carbodilite V-05”, “Elastostab H01”, and “Carbodilite V-04PF” (the above are names of products manufactured by Nisshinbo Chemical Inc.).

The above carbodiimide group-containing compound (C), when comprising an isocyanate group, preferably has two or more isocyanate groups and more preferably has two isocyanate groups, from the viewpoint of water-resistant adhesion of the coating film to be formed.

Commercially available products can be used as the above carbodiimide group-containing compound having isocyanate groups. Trade names of commercially available products can include “Carbodilite V-05” and “Carbodilite V-07” (the above are names of products manufactured by Nisshinbo Chemical Inc.).

Commercially available products can be used as the above carbodiimide group-containing compound having an aromatic ring structure. Trade names of commercially available products can include “Carbodilite V-05”, “Elastostab H01”, “Carbodilite V-04PF”, “Carbodilite V-09M”, and “Carbodilite V-09 GB” (the above are names of products manufactured by Nisshinbo Chemical Inc.).

The number average molecular weight of the above carbodiimide group-containing compound (C), from the viewpoint of a decrease in VOC content in the resulting coating composition and the viewpoint of water-resistant adhesion of the coating film to be formed, is preferably within the range of 500 to 5000, more preferably within the range of 600 to 3000, and even more preferably within the range of 700 to 1500.

The content of the above carbodiimide group-containing compound (C) in the coating composition of the present invention, from the viewpoint of water-resistant adhesion of the coating film to be formed, is preferably within the range of 0.5 to 5 mass %, more preferably within the range of 0.8 to 4 mass %, and even more preferably within the range of 1.0 to 3 mass %, based on the total amount of the coating composition.

### [Internal Release Agent (D)]

The coating composition of the present invention, when used as an in-mold coating composition, preferably contains an internal release agent (D), from the viewpoint of mold releasability between the coating film to be formed and the mold. Examples of the above internal release agent (D) can include saturated fatty acids such as stearic acid and palmitic acid; saturated fatty acid salts such as zinc stearate, aluminum stearate, magnesium stearate, calcium stearate, sodium stearate, potassium stearate, barium stearate, zinc palmitate, aluminum palmitate, magnesium palmitate, calcium palmitate, and sodium palmitate; saturated fatty acid amides such as lauramide, myristamide, palmitamide, stearamide, N,N-dimethyllauramide, N,N-dimethylmyristamide, N,N-dimethylpalmitamide, N,N-dimethylstearamide, N,N-diethylauramide, N,N-diethylmyristamide, N,N-diethylpalmitamide, and N,N-diethylstearamide; unsaturated fatty acids such as palmitoleic acid and oleic acid; unsaturated fatty acid salts such as zinc palmitoleate, aluminum palmitoleate, magnesium palmitoleate, calcium palmitoleate, sodium palmitoleate, potassium palmitoleate, barium palmitoleate, zinc oleate, aluminum oleate, magnesium oleate, calcium oleate, sodium oleate, potassium oleate, and barium oleate; unsaturated fatty acid amides such as palmitoleamide, oleamide, erucamide, behenamide, N-oleylpalmitamide, N-stearylerucamide, N,N-dimethyloleamide, and N,N-diethyloleamide; nonionic surfactants such as polyoxyethylene alkyl ethers and sorbitan alkyl ester; fluorine-based compounds such as polytetrafluoroethylene, fluoropolyethers, perfluoroalkyl esters, and perfluoroalkyl ester salts; phosphate ester compounds such as phosphate monoesters and/or phosphate diesters having alkyl chains or oxyethylene chains; fatty acid esters such as stearic acid monoglyceride, stearic acid diglyceride, stearic acid triglyceride, stearic acid monosorbitate, stearyl stearate, palmitic acid monoglyceride, palmitic acid diglyceride, palmitic acid triglyceride, behenic acid monoglyceride, behenic acid diglyceride, behenic acid triglyceride, behenyl behenate, pentaerythritol monostearate, pentaerythritol tetrastearate, pentaerythritol tetrapelargonate, propylene glycol monostearate, stearyl stearate, palmityl palmitate, methyl stearate, butyl stearate, methyl laurate, methyl palmitate, isopropyl palmitate, biphenyl biphenate, sorbitan monostearate, and 2-ethylhexyl stearate; soybean oil lecithin, silicone oil, and fatty alcohol dibasic acid esters. These can be used independently or in combination of two or more.

The above internal release agent (D), from the viewpoints of water-resistant adhesion, weather resistance, and transparency of the coating film to be formed and mold releasability between the coating film to be formed and the mold, preferably comprises a fatty acid amide, more preferably comprises a fatty acid tertiary amide, and even more preferably comprises a fatty acid tertiary dimethylamide.

Examples of the above fatty acid amide can include saturated fatty acid amides such as lauramide, myristamide, palmitamide, stearamide, N,N-dimethyllauramide, N,N-dimethylmyristamide, N,N-dimethylpalmitamide, N,N-dimethylstearamide, N,N-diethyllauramide, N,N-diethylmyristamide, N,N-diethylpalmitamide, and N,N-diethylstearamide; and unsaturated fatty acid amides such as palmitoleamide, oleamide, erucamide, behenamide, N-oleylpalmitamide, N-stearylerucamide, N,N-diethyloleamide, and N,N-diethyloleamide.

Commercially available products can be used as the above internal release agent comprising a fatty acid amide. Trade names of commercially available products can include “INT-120IMC” (the above is name of product manufactured by Axel Plastics Research Laboratory, Inc.), “Amide AP-1”, “Diamide Y”, “Diamide 0-200”, “Diamide I-200” (the above are names of products manufactured by Mitsubishi Chemical Corporation), “NEUTRON”, “NEUTRON-2”, “NEUTRON-S”, “NEUTRON BNT-22H”, “NEUTRON PNT-34”, “NEUTRON SNT-F” (the above are names of products manufactured by Nippon Fine Chemical Co., Ltd.), “ALFLOW S-10”, “ALFLOW E-10”, “ALFLOW P-10” (the above are names of products manufactured by NOF Corporation), “Armoslip CP powder”, “Armoslip HT powder”, “Armoslip E” (the above are names of products manufactured by Lion Specialty Chemicals Co., Ltd.), “Fatty Acid Amide S”, “Fatty Acid Amide O—N”, and “Fatty Acid Amide E” (the above are names of products manufactured by Kao Corporation).

When the above internal release agent (D) comprises the above fatty acid amide, the content of the fatty acid amide, from the viewpoints of water-resistant adhesion and transparency of the coating film to be formed and the viewpoint of mold releasability between the coating film to be formed and the mold, is preferably within the range of 30 to 100 mass %, more preferably within the range of 50 to 100 mass %, and even more preferably within the range of 70 to 100 mass %, based on the total amount of the internal release agent (D).

Examples of the above fatty acid tertiary amide can include N,N-dimethyllauramide, N,N-dimethylmyristamide, N,N-dimethylpalmitamide, N,N-dimethylstearamide, N,N-diethyllauramide, N,N-diethylmyristamide, N,N-diethylpalmitamide, N,N-diethylstearamide, and N,N-diethyloleamide. Commercially available products can be used as the above internal release agent comprising a fatty acid tertiary amide. Trade names of commercially available product can include “INT-120IMC” (trade name, manufactured by Axel Plastics Research Laboratory, Inc.).

When the above internal release agent (D) comprises a fatty acid tertiary amide, the content of the fatty acid tertiary amide, from the viewpoints of water-resistant adhesion and transparency of the coating film to be formed and mold releasability between the coating film to be formed and the mold, is preferably within the range of 20 to 100 mass %, more preferably within the range of 35 to 100 mass %, and even more preferably within the range of 50 to 100 mass %, based on the total amount of the internal release agent (D).

Examples of the above fatty acid tertiary dimethylamide can include N,N-dimethyllauramide, N,N-dimethylmyristamide, N,N-dimethylpalmitamide, N,N-dimethylstearamide, and N,N-dimethyloleamide. Commercially available products can be used as the above internal release agent comprising a fatty acid tertiary dimethylamide. Trade names of commercially available products can include “INT-120IMC” (trade name, manufactured by Axel Plastics Research Laboratory, Inc.).

When the above internal release agent (D) comprises a fatty acid tertiary dimethylamide, the content of the fatty acid tertiary dimethylamide, from the viewpoints of water-resistant adhesion and transparency of the coating film to be formed and mold releasability between the coating film to be formed and the mold, is preferably within the range of 20 to 100 mass %, more preferably within the range of 35 to 100 mass %, and even more preferably within the range of 50 to 100 mass %, based on the total amount of the internal release agent (D).

When the coating composition of the present invention contains the above internal release agent (D), the content of the internal release agent (D), from the viewpoints of weather resistance, water-resistant adhesion, and transparency of the coating film to be formed and mold releasability between the coating film to be formed and the mold, is preferably within the range of 0.4 to 1.5 mass %, more preferably within the range of 0.5 to 1.2 mass %, and even more preferably within the range of 0.5 to 1.0 mass %, based on the total amount of the coating composition.

### [Additional Components]

The coating composition of the present invention, in addition to the above, can further contain an ultraviolet absorber and/or a photostabilizer. In addition, the coating composition of the present invention can appropriately contain, as needed, additional components generally used in the field of coatings, such as a crosslinker, a solvent (organic solvent or water), a pigment, a catalyst, a dehydrating agent, an antioxidant, a surface conditioner, an antifoaming agent, an emulsifier, a surfactant, an antifouling agent, a wetting agent, a thickener, a dye, an agent for improving scratch resistance, and a gloss adjuster.

### [Ultraviolet Absorber]

Any known ultraviolet absorber from the prior art can be used as the ultraviolet absorber. For example, a benzotriazole-based absorber, a triazine-based absorber, a salicylic acid derivative-based absorber, or a benzophenone-based absorber can be used. The above ultraviolet absorber may have a polymerizable unsaturated group.

Specific examples of the above benzotriazole-based absorber include 2-(2′-hydroxy-5′-methylphenyl)benzotriazole, 2-(2′-hydroxy-5′-t-butylphenyl)benzotriazole, 2-(2′-hydroxy-3′,5′-di-t-butylphenyl)benzotriazole, 2-(2′-hydroxy-3′-t-butyl-5′-methylphenyl)-5-chlorobenzotriazole, 2-(2′-hydroxy-3′,5′-di-t-butylphenyl)-5-chlorobenzotriazole, 2-(2′-hydroxy-3′,5′-di-t-amylphenyl)benzotriazole, 2-(2′-hydroxy-4′-octoxyphenyl)benzotriazole, 2-{2′-hydroxy-3′-(3″,4″,5″,6″-tetrahydrophthalimidomethyl)-5′-methylphenyl}benzotriazole, and 2-[2-hydroxy-5-[2-(methacryloyloxy)ethyl]phenyl]-2H-benzotriazole.

Specific examples of the above triazine-based absorber include 2,4-bis(2,4-dimethylphenyl)-6-(2-hydroxy-4-isooctyloxyphenyl)-1,3,5-triazine, 2-[4((2-hydroxy-3-dodecyloxypropyl)-oxy)-2-hydroxyphenyl]-4,6-bis(2,4-dimethylphenyl)-1,3,5-triazine, 2-[4-((2-hydroxy-3-tridecyloxypropyl)-oxy)-2-hydroxyphenyl]-4,6-bis(2,4-dimethylphenyl)-1,3,5-triazine, and 2-(2,4-dihydroxyphenyl)-4,6-bis(2,4-dimethylphenyl)-1,3,5-triazine.

Specific examples of the above salicylic acid derivative-based absorber include phenyl salicylate, p-octylphenyl salicylate, and 4-tert-butylphenyl salicylate.

Specific examples of the above benzophenone-based absorber include 4-dihydroxybenzophenone, 2-hydroxy-4-methoxybenzophenone, 2,2′-dihydroxy-4-methoxybenzophenone, 2-hydroxy-4-methoxy-2′-carboxybenzophenone, 2-hydroxy-4-methoxy-5-sulfobenzophenone trihydrate, 2,2′-dihydroxy-4,4′-dimethoxybenzophenone, 2-hydroxy-4-octoxybenzophenone, 2-hydroxy-4-octadecyloxybenzophenone, sodium 2,2′-dihydroxy-4,4′-dimethoxy-5-sulfobenzophenone, 2,2′,4,4′-tetrahydroxybenzophenone, 4-dodecyloxy-2-hydroxybenzophenone, 5-chloro-2-hydroxybenzophenone, resorcinol monobenzoate, 2,4-dibenzoylresorcinol, 4,6-dibenzoylresorcinol, hydroxydodecylbenzophenone, and 2,2′-dihydroxy-4(3-methacryloxy-2-hydroxypropoxy)benzophenone.

Examples of commercially available products of the above ultraviolet absorber include “TINUVIN 1130”, “TINUVIN 900”, “TINUVIN 928”, “TINUVIN 384-2”, “TINUVIN 479”, “TINUVIN 477”, “TINUVIN 405”, “TINUVIN 400”, (manufactured by BASF SE, trade name, TINUVIN is a registered trademark), and “RUVA 93” (manufactured by Otsuka Chemical Co., Ltd., trade name).

When the coating composition of the present invention contains the above ultraviolet absorber, the content of the ultraviolet absorber, from the viewpoint of weather resistance of the coating film to be formed, is preferably within the range of 0.5 to 10 mass %, more preferably within the range of 0.8 to 5.0 mass %, and even more preferably within the range of 1.0 to 3.0 mass %, based on the total amount of the coating composition.

### [Photostabilizer]

The above photostabilizer is used as a radical chain inhibitor that captures active radicals generated in the deterioration process of the coating film, and examples include photostabilizers of hindered amine compounds.

Examples of the above hindered amine compound include, but are not limited to, monomer-type hindered amine compounds such as bis(1,2,2,6,6-pentamethyl-4-piperidyl)sebacate, bis(2,2,6,6-tetramethyl-4-piperidinyl)sebacate, bis(N-methyl-2,2,6,6-tetramethyl-4-piperidinyl)sebacate, 4-benzoyloxy-2,2′,6,6′-tetramethylpiperidine, bis(1,2,2,6,6-pentamethyl-4-piperidyl){[3,5-bis(1,1-dimethylethyl)-4-hydroxyphenyl]methyl}butylmalonate; oligomer-type hindered amine compounds such as poly{[6-(1,1,3,3-tetramethylbutyl)imino-1,3,5-triazine-2,4-diyl][(2,2,6,6,-tetramethyl-4-piperidyl)imino]hexamethylene[(2,2,6,6-tetramethyl-4-piperidyl)iminol]}; and polyester bond-type hindered amine compounds such as polyesterification product of 4-hydroxy-2,2,6,6-tetramethyl-1-piperidine ethanol and succinic acid. As the photostabilizer, any known polymerizable photostabilizer can also be used.

Examples of the above photostabilizer include “TINUVIN 123”, “TINUVIN 152”, “TINUVIN 249”, “TINUVIN 292” (manufactured by BASF SE, trade name, TINUVIN is a registered trademark), “HOSTAVIN 3058” (manufactured by Clariant, trade name, Hostavin is a registered trademark), and “ADK STAB LA-82” (manufactured by Adeka Corporation, trade name, ADK STAB is a registered trademark).

When the coating composition of the present invention contains the above photostabilizer, the content of the photostabilizer, from the viewpoint of weather resistance of the coating film to be formed, is preferably within the range of 0.5 to 10 mass %, more preferably within the range of 0.8 to 7.5 mass %, and even more preferably within the range of 1.0 to 5.0 mass %, based on the total amount of the coating composition.

### [Solvent]

As the above solvent, for example, an organic solvent or water can be used. Examples of the organic solvent include ketone-based solvents such as acetone, methyl ethyl ketone, and methyl isobutyl ketone; ester-based solvents such as ethyl acetate, butyl acetate, methyl benzoate, ethyl ethoxypropionate, ethyl propionate, and methyl propionate; ether-based solvents such as tetrahydrofuran, dioxane, and dimethoxyethane; glycol ether-based solvents such as ethylene glycol monomethyl ether, ethylene glycol monoethyl ether, diethylene glycol monomethyl ether, propylene glycol monomethyl ether acetate, and 3-methoxybutyl acetate; aromatic solvents such as toluene, xylene, “Swazole 1000” (manufactured by Cosmo Oil Co., Ltd., trade name, high boiling point petroleum-based solvent); and aliphatic hydrocarbon-based solvents such as hexane and heptane.

The content of the above solvent in the coating composition of the present invention is within the range of 0 to 10 mass % based on the total amount of the coating composition. The content of the above solvent in the coating composition of the present invention, from the viewpoints of a decrease in VOC content in the resulting coating composition and pinhole resistance of the coating film to be formed, is preferably within the range of 0 to 5 mass % and more preferably within the range of 0 to 3 mass %.

### [Pigment]

Examples of the above pigment can include glitter pigments, color pigments, and extender pigments. The pigments can be used independently or in combination of two or more.

Examples of the above glitter pigment include aluminum (including vapor-deposited aluminum), copper, zinc, brass, nickel, glass flake, aluminum oxide, mica, aluminum oxide coated with titanium oxide and/or iron oxide, and mica coated with titanium oxide and/or iron oxide.

Examples of the above color pigment include titanium oxide, zinc oxide, carbon black, molybdenum red, Prussian blue, cobalt blue, azo-based pigments, phthalocyanine-based pigments, quinacridone-based pigments, isoindoline-based pigments, threne-based pigment, perlyene-based pigments, dioxazine-based pigments, diketopyrrolopyrrole-based pigments, and heat-shielding pigments.

Examples of the above extender pigment include clay, kaolin, barium sulfate, barium carbonate, calcium carbonate, talc, silica, and alumina white.

When the coating composition of the present invention contains the above pigment, the content of the pigment, from the viewpoints of water-resistant adhesion, hardness, and weather resistance of the coating film to be formed, is preferably within the range of 0.1 to 40 mass %, more preferably within the range of 0.5 to 30 mass %, and even more preferably within the range of 0.7 to 20 mass %, based on the total amount in the coating composition.

### [Catalyst]

Any known catalyst from the prior art can be used as the catalyst. Examples of the above catalyst include organometallic compounds such as stannous octoate, dibutyltin diacetate, dibutyltin di(2-ethylhexanoate), dibutyltin dilaurate, dioctyltin diacetate, dioctyltin di(2-ethylhexanoate), dioctyltin dineodecanoate, dioctyltin diversatate, dibutyltin oxide, dibutyltin sulfide, dioctyltin oxide, dibutyltin fatty acid salt, lead 2-ethylhexanoate, zinc octoate, zinc naphthenate, zinc fatty acids, bismuth octanoate, bismuth 2-ethylhexanoate, bismuth oleate, bismuth neodecanoate, bismuth versatate, bismuth naphthenate, cobalt naphthenate, calcium octoate, copper naphthenate, tetra(2-ethylhexyl) titanate, tetra(n-butyl) titanate, titanium diisopropoxybis(acetylacetonate), titanium tetraacetylacetonate, titanium diisopropoxybis(ethylacetoacetate), titanium butoxide dimer, zirconium tetra-normal propoxide, zirconium tetra-normal butoxide, zirconium tetraacetylacetonate, and zirconium tributoxy monoacetylacetonate; tertiary amine compounds such as triethylamine, N,N′-dimethylcyclohexylamine, N,N,N′,N′-tetramethylethylenediamine, N,N,N′,N′-tetramethylhexamethylenediamine, N,N,N′N″,N″-pentamethyldiethylenetriamine, N,N,N′,N″,N″-pentamethylpropylenetriamine, 1,4-diazabicyclo[2.2.2.]octane (DABCO), 1,8-diazabicyclo[5.4.0.]-7-undecene (DBU), 1,5-diazabicyclo[4.3.0.]-5-nonene (DBN), N-methyl-N′-(2-dimethylaminoethyl)piperazine, N-ethylmorpholine, 1,2-dimethylimidazole, dimethylethanolamine, dimethylaminoethoxyethanol, N-methyl-N′-(2-hydroxyethyl)piperazine, 2-hydroxyethyl-1,4-diazabicyclo[2.2.2.]octane, 1,1′-{[3-(dimethylamino)propyl]imino}bis(2-propanol), bis(2-dimethylaminoethyl)ether, and bis(2-morpholinoethyl)ether, and neutralizing salts of the tertiary amine compounds; and quaternary ammonium salts such as carboxylates of tetraalkylammonium, tetraarylammonium, and alkylarylammonium and halides of tetraalkylammonium, tetraarylammonium, and alkylarylammonium. These can each be used independently or in combination of two or more.

When the coating composition of the present invention contains the above catalyst, from the viewpoints of hardness and weather resistance of the coating film to be formed, the blending amount of the catalyst is preferably within the range of 0.005 to 2 mass % and more preferably within the range of 0.01 to 1 mass %, based on the total amount of the coating composition.

When the coating composition of the present invention contains the above catalyst, the coating composition of the present invention may contain organic acids such as acetic acid, propionic acid, butyric acid, isopentanoic acid, hexanoic acid, 2-ethylbutyric acid, naphthenic acid, octanoic acid, nonanoic acid, decanoic acid, 2-ethylhexanoic acid, isooctanoic acid, isononanoic acid, lauric acid, palmitic acid, stearic acid, oleic acid, linoleic acid, neodecanoic acid, versatic acid, isobutyric anhydride, itaconic anhydride, acetic anhydride, citraconic anhydride, propionic anhydride, maleic anhydride, butyric anhydride, citric anhydride, trimellitic anhydride, pyromellitic anhydride, and phthalic anhydride; inorganic acids such as hydrochloric acid and phosphoric acid; and metal coordination compounds such as acetylacetone and imidazole-based compounds.

### [Dehydrating Agent]

As the dehydrating agent, conventionally known inorganic dehydrating agents and organic dehydrating agents can be used. Examples of the above inorganic dehydrating agent include calcium compounds such as calcium hydride, calcium oxide (quick lime), calcium chloride, and calcium sulfate (gypsum); barium compounds such as barium oxide; magnesium compounds such as magnesium sulfate; sodium compounds such as sodium sulfate and sodium carbonate; copper compounds such as copper sulfate; inorganic silicon compounds such as silica gel; and aluminum compounds such as aluminum oxide (hydraulic alumina, lithium aluminum hydride, non-crystalline silica alumina, crystalline aluminosilicate (molecular sieve). These can each be used independently or in combination of two or more. Examples of the above organic dehydrating agent include alkyl orthoformate; alkyl orthoacetate; alkyl orthoborate; vinylsilane; alkoxysilane compounds; monoisocyanate compounds; aliphatic acid anhydrides such as acetic anhydride, and aromatic acid anhydrides such as benzoic anhydride. These can each be used independently or in combination with two or more.

When the coating composition of the present invention contains the above dehydrating agent, from the viewpoint of pinhole resistance of the coating film to be formed, the content of the dehydrating agent is preferably within the range of 0.1 to 2 mass % and more preferably within the range of 0.3 to 1 mass %, based on the total amount of the coating composition.

[Coating Film Formation Method with Coating Composition]

The coating composition of the present invention is coated on a substrate to form a wet coating film (uncured coating film), and the wet coating film is then cured, whereby a target coating film can be formed. The above substrate, from the viewpoint of water-resistant adhesion of the coating film to be formed, is preferably composed of a resin material.

Examples of the above resin material can include acrylic resins such as polymethyl methacrylate; polyester resins such as polyethylene terephthalate, polyethylene naphthalate, poly-1,4-cyclohexanedimethylene terephthalate, polyethylene-1,2-diphenoxyethane-4,4′-dicarboxylate, and polybutylene terephthalate; epoxy resins represented by commercially available products such as Epicoat (trade name: manufactured by Yuka Shell Epoxy KK), polycarbonate resins, polyimide resins, novolac resins, phenolic resins, acrylonitrile-butadiene-styrene (ABS) resin, acrylonitrile-ethylene-styrene (AES) resin, acrylonitrile-styrene-acrylate (ASA) resin, vinyl chloride resins, vinylidene chloride resins, polyurethane resins, cellulose ester resins (e.g., triacetyl cellulose, diacetyl cellulose, propionyl cellulose, butyryl cellulose, acetylpropionyl cellulose, nitrocellulose), polyamide resins, polystyrene resins (e.g., syndiotactic polystyrene), polyolefin resins (e.g., polypropylene, polyethylene, polymethylpentene), polysulfone resins, polyethersulfone resins, polyarylate resins, polyetherimide resins, polyetherketone resins, various fiber-reinforced plastic materials (hereinafter sometimes abbreviated as FRP materials or simply FRP), and polymer alloys thereof.

The substrate, for example, may be the above resin material having a primer coating material, an intermediate coating material, or a top coating material coated thereon so that a primer layer, an intermediate coat layer, or a top coat layer is formed in advance.

The above substrate may be subjected to a treatment by at least one physical method (physical treatment) selected from plasma treatment, corona discharge treatment, active energy ray treatment, flame treatment, blast treatment, and polishing treatment.

It is preferable that the coating composition of the present invention be applied directly onto the substrate.

The application of the molding coated with the coating composition of the present invention is not particularly limited, and examples can include outer panels of automobile bodies of passenger cars, trucks, motorcycles, and buses; interior and exterior parts of automobiles such as bumpers, center pillars, mirrors, door handles, instrument panels, door trims, and center consoles; furniture and building material-related parts such as chairs, vanity mirrors, window frames, and gates; and outer panels of household electrical appliances such as mobile phones and audio equipment.

The method of applying the coating composition of the present invention onto a substrate is not particularly limited. Application can be carried out, for example, by air spraying, airless spraying, rotary atomizer, dip coating, applicator, brush, roller, or in-mold coating. During application, an electrostatic charge may be applied.

The applied film thickness, or cured film thickness, is preferably within the range of 5 to 2000 μm, more preferably within the range of 10 to 1500 μm, and even more preferably within the range of 15 to 1000 μm.

By heating the coating composition of the present invention, the coating composition applied on a substrate can be cured.

### [Heating]

For heating, any method known in the field can be appropriately used, and specifically, can be carried out by using, for example, hot air, hot gas, an infrared heater, an IR radiator, an oven, a heat roller, a hot press, or a microwave. In the present invention, from the viewpoint of ease of operation, heating is preferably carried out by hot air, an infrared heater, or a hot press.

The temperature of the above heating, from the viewpoints of productivity, workability, and thermal stability of the substrate, is preferably within the range of 30 to 200° C., more preferably within the range of 50 to 180° C., and even more preferably within the range of 70 to 160° C. In addition, the time of the above heating is preferably within the range of 20 s to 60 min and more preferably within the range of 40 s to 10 min.

The coating composition of the present invention can be suitably used in coating by an in-mold coating method. The in-mold coating method has the advantages of being able to use a coating composition generally having a low VOC content and also being able to reduce air-conditioning energy during coating, whereby environmental burden can be reduced.

### [In-Mold Coating Method]

The in-mold coating method according to the present invention comprises a step of injecting the coating composition of the present invention (hereinafter, when using the coating composition of the present invention in the in-mold coating method, it is referred to as in-mold coating composition) between a molded substrate and the inner walls of a mold, curing the in-mold coating composition, and then removing a coated molding from the mold.

As the in-mold coating method, any conventional method of molding and coating in a mold can be used without any particular limits. Specifically, for example, the methods described in Japanese Unexamined Patent Publication (Kokai) No. 2000-141407 and Japanese Unexamined PCT Publication (Kohyo) No. 2008-525212 can be used. Note that the resin-molding molds used when molding the resin material and the in-mold coating molds used during in-mold coating with the in-mold coating composition may be the same or different.

When the above resin-molding molds and in-mold coating molds are the same, for example, a resin material that has been heat-melted within an injection cylinder is injected between resin-molding molds having the shape of the intended molded article, which is then cooled and pressurized within the resin-molding molds to form the resin material into a molding, and further, the resin-molding molds are separated from the surfaces of the molding made of resin material. Next, a gap sufficient for injecting the in-mold coating composition is provided between the surfaces of the molding made of resin and the in-mold coating molds, the above in-mold coating composition is injected between the surfaces of the molding made of resin material and the in-mold coating inner walls of mold, the in-mold coating molds are closed, and an uncured in-mold coating film is formed on the molding made of resin material. Next, the uncured in-mold coating film formed on the molding made of resin material is heated and molded into the intended shape to form a cured in-mold coating film on the molding made of resin material, whereby an in-mold coated molding can be obtained.

When the above resin-molding molds and the first coating film-coated molds are different, for example, a resin material that has been heat-melted within an injection cylinder is injected between resin-molding molds having the shape of the intended molded article, which is then cooled and pressurized within the resin-molding molds to form the resin material into a molding, and further, the resin-molding molds are separated from the surfaces of the molding made of resin material and then removed. Next, the in-mold coating molds are brought near the surfaces of the resin molding, a gap sufficient for injecting the in-mold coating composition is provided between the surfaces of the molding made of resin material and the in-mold coating molds, the above in-mold coating composition is injected between the surfaces of the molding made of resin material and the in-mold coating inner walls of mold, the in-mold coating molds are closed, and an uncured in-mold coating film is formed on the molding made of resin material. Next, the uncured in-mold coating film formed on the molding made of resin material is heated and molded into the intended shape to form a cured in-mold coating film on the molding made of resin material, whereby an in-mold coated molding can be obtained.

From the viewpoint of mold releasability between the above in-mold coated molding and the in-mold coating mold, an external release agent may be applied to the above mold. As the external release agent, for example, fluorine-based, silicone-based, surfactant-based, and wax-based external release agents can be used.

The heating temperature when melting the resin in the injection cylinder is arbitrarily determined by the type of resin material, but is preferably 80 to 300° C. The temperature of the mold when injecting the resin material is arbitrarily determined by the molding time and the type of resin material, but is preferably 30 to 120° C. The molding time of the resin material may be until complete solidification of the resin material, but needs only to be one in which the resin material is solidified to a strength that does not impair the molded shape when the above in-mold coating composition is injected, and is generally preferably 20 s to 60 min.

The amount of the above in-mold coating composition injected is an amount sufficient to obtain a desired film thickness, and is preferably an amount sufficient to obtain a cured film thickness of 15 to 2000 μm.

The heating temperature when heating the above uncured in-mold coating film is preferably within the range of 20 to 160° C., more preferably within the range of 40 to 150° C., and even more preferably within the range of 60 to 140° C. In addition, the heating time when heating the above uncured in-mold coating film is preferably within the range of 20 s to 10 min, more preferably within the range of 30 s to 5 min, and even more preferably within the range of 40 s or 4 min.

It is preferable that pressure be applied when the above uncured in-mold coating film is heated and cured. When applying pressure described above, the pressure is preferably within the range of 2 to 14 MPa from the viewpoints of water-resistant adhesion and pinhole resistance of the coating film to be formed.

### EXAMPLES

Hereinafter, the present invention will be further specifically described with reference to the Production Examples, Examples, and Comparative Examples. Note that the Production Examples, Examples, and Comparative Examples are merely examples, and the scope of the present invention is not limited thereto. In the Production Examples, Examples, and Comparative Examples, “parts” and “%” are based on mass unless otherwise specified. In addition, the thickness of a coating film is based on cured coating film.

The components used in the examples below are as follows.

### Production of Carbodiimide Group-Containing Compound (C)

### Production Example 1

A reaction vessel equipped with a thermometer, a thermostat, a dry air inlet tube, a stirrer, and a reflux condenser was loaded with 100.0 parts of “Carbodilite V-05” (trade name, manufactured by Nisshinbo Chemical Inc., carbodiimide group-containing compound having an aromatic ring structure and two isocyanate groups, carbodiimide equivalent per solid content of 262, number average molecular weight of 800, solid content concentration of 100%), 0.04 parts of “NEOSTANN U-830” (trade name, manufactured by Nitto Kasei Co., Ltd., dioctyltin diversatate, solid content concentration of 100%), and 20.0 parts of methanol, and the contents of the reaction vessel were heated to 60° C. while stirred and mixed under dry air flow. The contents of the reaction vessel was then aged for 24 h, and disappearance of isocyanate groups was confirmed by IR (infrared light) analysis of the reaction product. Next, methanol was distilled away from the content of the reaction vessel at 60° C. under reduced pressure, and the content of the reaction vessel was then cooled to room temperature to obtain a carbodiimide group-containing compound (C-1) having a carbodiimide equivalent per solid content of 290, a number average molecular weight of 860, and a solid content concentration of 100%. The obtained carbodiimide group-containing compound had an aromatic ring structure and was free of isocyanate groups.

### Production of Pigment Dispersion Liquid (P)

### Production Example 2

4.7 parts of butyl acetate, 1 part of “Raven 5000 ULTRA III POWDER” (trade name, manufactured by Birla Carbon, carbon black pigment, solid content concentration of 100%), 0.1 parts of “SOLSPERSE 5000S” (trade name, manufactured by Lubrizol Corporation, phthalocyanine pigment derivative, solid content concentration of 100%), and 1 part of “DISPERBYK-2013” (trade name, manufactured by BYK-Chemie, dispersant, solid content concentration of 100%) were placed in a container equipped with a stirring apparatus, and the contents of the container were uniformly mixed. The obtained mixed solution and glass beads having a diameter of about 1.3 mm<p as a dispersion medium were placed in wide-mouthed glass bottle and sealed, and the mixed solution was dispersed for 4 h with a paint shaker to obtain a pigment dispersion liquid (P-1).

### Production of Coating Composition

### Example 1

34.2 parts of “Desmophen XP2488” (trade name, manufactured by Covestro AG, hydroxyl group-containing polyester resin comprising 26% hydroxyl group-containing monomer, solid content concentration of 100%), 60.4 parts of “Desmodur N3900” (trade name, manufactured by Sumika Covestro Urethane Co., Ltd., iminooxadiazinedione of hexamethylene diisocyanate, solid content concentration of 100%), 1.5 parts of “Carbodilite V-05” (trade name, manufactured by Nisshinbo Chemical Inc., carbodiimide group-containing compound having an aromatic ring structure and two isocyanate groups, carbodiimide equivalent per solid content of 262, number average molecular weight of 800, solid content concentration of 100%), 0.1 parts of “BYK-333” (trade name, manufactured by BYK-Chemie, surface conditioner (polyether-modified polydimethylsiloxane), solid content concentration of 100%), 1.2 parts of “TINUVIN 400” (trade name, manufactured by BASF SE, triazine-based ultraviolet absorber, solid content concentration of 85%), 2.0 parts of “TINUVIN 292” (trade name, manufactured by BASF SE, photostabilizer of hindered amine compound, solid content concentration of 100%), and 0.6 parts of “NEOSTANN U-830” (trade name, manufactured by Nitto Kasei Co., Ltd., dioctyltin diversatate, solid content concentration of 100%) were blended in a container equipped with a stirring apparatus, and the contents of the container were uniformly mixed to obtain a coating composition No. 1 having a solid content concentration of 99%.

### Examples 2 to 25 and Comparative Examples 1 to 5

Coating compositions No. 2 to No. 30 were obtained in the same manner as in Example 1, except that the blending composition in Example 1 was changed to those shown in Tables 1-1 and 1-2.

TABLE 1-1

| | | | Example | | | | | | | |
|---|---|---|---|---|---|---|---|---|---|---|
| | | | 1 | 2 | 3 | 4 | 5 | 6 | 7 | 8 |
| Coating composition No. | | | 1 | 2 | 3 | 4 | 5 | 6 | 7 | 8 |
| Isocyanate- | Hydroxyl | Desmophen XP2488 | 34.2 | 34.2 | 33.6 | 33.9 | 34.6 | 34.5 | 32.9 | 32.5 |
| reactive | group- | Desmophen VPLS2249/1 | | | | | | | | |
| group- | containing | (Note 1) | | | | | | | | |
| containing | compound | Placcel 303 | | | | | | | | |
| compound (A) | (A1) | (Note 2) | | | | | | | | |
| | Amino group- | Desmophen NH1220 | | | | | | | | |
| | containing | (Note 3) | | | | | | | | |
| | compound | Desmophen NH1423 | | | | | | | | |
| | (A2) | (Note 4) | | | | | | | | |
| | | CLEARLINK 1000 | | | | | | | | |
| | | (Note 5) | | | | | | | | |
| | Thiol group- | TMMP-LV (Note 6) | | | | | | | | |
| | containing | TEMPIC (Note 7) | | | | | | | | |
| | compound | PEMP-LV (Note 8) | | | | | | | | |
| | (A3) | | | | | | | | | |
| Polyisocyanate | Desmodur N3900 | | 60.4 | 60.4 | 59.5 | 60.1 | 61.2 | 61.1 | 58.2 | 57.6 |
| compound (B) | Desmodur N3400 (Note 9) | | | | | | | | | |
| | Desmodur NZ200 (Note 10) | | | | | | | | | |
| | Desmodur N3600 (Note 11) | | | | | | | | | |
| Carbodiimide | Carbodilite V-05 | | 1.5 | | | | 0.3 | 0.5 | 5.0 | 6.0 |
| group- | Carbodiimide group-containing | | | 1.5 | | | | | | |
| containing | compound (C-1) | | | | | | | | | |
| compound (C) | Carbodilite V-03 (Note 12) | | | | 3.0 | | | | | |
| | Carbodilite V-09M (Note 13) | | | | | 2.1 | | | | |
| Pigment | Color | RAVEN 5000 ULTRA | | | | | | | | |
| dispersion | pigment | III POWDER | | | | | | | | |
| liquid (P-1) | Pigment | SOLSPERSE 5000S | | | | | | | | |
| | derivative | | | | | | | | | |
| | Dispersant | DISPERBYK-2013 | | | | | | | | |
| | Organic | Butyl acetate | | | | | | | | |
| | solvent | | | | | | | | | |

| | | | | | | | | | |
|---|---|---|---|---|---|---|---|---|---|
| Organic solvent | Butyl acetate | | | | | | | | |
| | Ethyl 3-ethoxypropionate | | | | | | | | |
| Surface | BYK-333 | 0.1 | 0.1 | 0.1 | 0.1 | 0.1 | 0.1 | 0.1 | 0.1 |
| conditioner | | | | | | | | | |
| Ultraviolet | TINUVIN 400 | 1.2 | 1.2 | 1.2 | 1.2 | 1.2 | 1.2 | 1.2 | 1.2 |
| absorber | | | | | | | | | |
| Photostabilizer | TINUVIN 292 | 2.0 | 2.0 | 2.0 | 2.0 | 2.0 | 2.0 | 2.0 | 2.0 |
| Catalyst | NEOSTANN U-830 | 0.6 | 0.6 | 0.6 | 0.6 | 0.6 | 0.6 | 0.6 | 0.6 |

| | | | | | | | | |
|---|---|---|---|---|---|---|---|---|
| Total | 100 | 100 | 100 | 100 | 100 | 100 | 100 | 100 |
| Solid content concentration (mass %) | 99 | 99 | 99 | 99 | 99 | 99 | 99 | 99 |

| | | | Example | | | | | | |
|---|---|---|---|---|---|---|---|---|---|
| | | | 9 | 10 | 11 | 12 | 13 | 14 | 15 |
| Coating composition No. | | | 9 | 10 | 11 | 12 | 13 | 14 | 15 |
| Isocyanate- | Hydroxyl | Desmophen XP2488 | 27.4 | 27.2 | 32.5 | 31.8 | 27.0 | 33.2 | |
| reactive | group- | Desmophen VPLS2249/1 | 6.8 | | | | 6.8 | | |
| group- | containing | (Note 1) | | | | | | | |
| containing | compound | Placcel 303 | | 6.8 | | | | | |
| compound (A) | (A1) | (Note 2) | | | | | | | |
| | Amino group- | Desmophen NH1220 | | | | | | | 39.7 |
| | containing | (Note 3) | | | | | | | |
| | compound | Desmophen NH1423 | | | | | | | 13.2 |
| | (A2) | (Note 4) | | | | | | | |
| | | CLEARLINK 1000 | | | | | | | |
| | | (Note 5) | | | | | | | |
| | Thiol group- | TMMP-LV (Note 6) | | | | | | | |
| | containing | TEMPIC (Note 7) | | | | | | | |
| | compound | PEMP-LV (Note 8) | | | | | | | |
| | (A3) | | | | | | | | |
| Polyisocyanate | Desmodur N3900 | | 60.4 | 60.5 | | | | 32.9 | 41.6 |
| compound (B) | Desmodur N3400 (Note 9) | | | | 62.1 | | | 8.0 | |
| | Desmodur NZ200 (Note 10) | | | | | 62.8 | | 20.4 | |
| | Desmodur N3600 (Note 11) | | | | | | 60.7 | | |
| Carbodiimide | Carbodilite V-05 | | 1.5 | 1.5 | 1.5 | 1.5 | 1.5 | 1.5 | 1.5 |
| group- | Carbodiimide group-containing | | | | | | | | |
| containing | compound (C-1) | | | | | | | | |
| compound (C) | Carbodilite V-03 (Note 12) | | | | | | | | |
| | Carbodilite V-09M (Note 13) | | | | | | | | |
| Pigment | Color | RAVEN 5000 ULTRA | | | | | | | |
| dispersion | pigment | III POWDER | | | | | | | |
| liquid (P-1) | Pigment | SOLSPERSE 5000S | | | | | | | |
| | derivative | | | | | | | | |
| | Dispersant | DISPERBYK-2013 | | | | | | | |
| | Organic | Butyl acetate | | | | | | | |
| | solvent | | | | | | | | |

| | | | | | | | | |
|---|---|---|---|---|---|---|---|---|
| Organic solvent | Butyl acetate | | | | | | | |
| | Ethyl 3-ethoxypropionate | | | | | | | |
| Surface | BYK-333 | 0.1 | 0.1 | 0.1 | 0.1 | 0.1 | 0.1 | 0.1 |
| conditioner | | | | | | | | |
| Ultraviolet | TINUVIN 400 | 1.2 | 1.2 | 1.2 | 1.2 | 1.2 | 1.2 | 1.2 |
| absorber | | | | | | | | |
| Photostabilizer | TINUVIN 292 | 2.0 | 2.0 | 2.0 | 2.0 | 2.0 | 2.0 | 2.0 |
| Catalyst | NEOSTANN U-830 | 0.6 | 0.6 | 0.6 | 0.6 | 0.6 | 0.6 | 0.6 |

| | | | | | | | |
|---|---|---|---|---|---|---|---|
| Total | 100 | 100 | 100 | 100 | 100 | 100 | 100 |
| Solid content concentration (mass %) | 99 | 99 | 99 | 99 | 99 | 99 | 99 |

TABLE 1-2

| | | | Example | | | | | | | |
|---|---|---|---|---|---|---|---|---|---|---|
| | | | 16 | 17 | 18 | 19 | 20 | 21 | 22 | 23 |
| Coating composition No. | | | 16 | 17 | 18 | 19 | 20 | 21 | 22 | 23 |
| Isocyanate- | Hydroxyl | Desmophen XP2488 | | | 28.6 | | | | 28.2 | 31.7 |
| reactive | group- | Desmophen VPLS2249/1 | | | | | | | | |
| group- | containing | (Note 1) | | | | | | | | |
| containing | compound (A1) | Placcel 303 | | | | | | | | |
| compound (A) | | (Note 2) | | | | | | | | |
| | Amino | Desmophen NH1220 | 39.7 | | | | | | | |
| | group- | (Note 3) | | | | | | | | |
| | containing | Desmophen NH1423 | 13.2 | 39.3 | | | | | | |
| | compound (A2) | (Note 4) | | | | | | | | |
| | | CLEARLINK | | 13.1 | 7.2 | | | | | |
| | | 1000 (Note 5) | | | | | | | | |
| | Thiol group- | TMMP-LV (Note 6) | | | | 11.0 | 11.0 | | 7.0 | |
| | containing | TEMPIC (Note 7) | | | | 33.1 | 33.1 | 32.6 | | |
| | compound | PEMP-LV (Note 8) | | | | | | 10.9 | | |
| | (A3) | | | | | | | | | |
| Polyisocyanate | Desmodur N3900 | | 41.6 | 42.2 | 58.8 | 50.5 | 50.5 | 51.1 | 59.4 | 56.1 |
| compound (B) | Desmodur N3400 (Note 9) | | | | | | | | | |
| | Desmodur NZ200 (Note 10) | | | | | | | | | |
| | Desmodur N3600 (Note 11) | | | | | | | | | |
| Carbodiimide | Carbodilite V-05 | | | 1.5 | 1.5 | 1.5 | | 1.5 | 1.5 | 1.5 |
| group- | Carbodiimide group- | | 1.5 | | | | 1.5 | | | |
| containing | containing compound (C-1) | | | | | | | | | |
| compound (C) | Carbodilite V-03 (Note 12) | | | | | | | | | |
| | Carbodilite V-09M (Note 13) | | | | | | | | | |
| Pigment | Color pigment | RAVEN 5000 | | | | | | | | 1.0 |
| dispersion | | ULTRA III POWDER | | | | | | | | |
| liquid (P-1) | Pigment | SOLSPERSE 5000S | | | | | | | | 0.1 |
| | derivative | | | | | | | | | |
| | Dispersant | DISPERBYK-2013 | | | | | | | | 1.0 |
| | Organic solvent | Butyl acetate | | | | | | | | 4.7 |

| | | | | | | | | | |
|---|---|---|---|---|---|---|---|---|---|
| Organic solvent | Butyl acetate | | | | | | | | |
| | Ethyl 3-ethoxypropionate | | | | | | | | |
| Surface | BYK-333 | 0.1 | 0.1 | 0.1 | 0.1 | 0.1 | 0.1 | 0.1 | 0.1 |
| conditioner | | | | | | | | | |
| Ultraviolet | TINUVIN 400 | 1.2 | 1.2 | 1.2 | 1.2 | 1.2 | 1.2 | 1.2 | 1.2 |
| absorber | | | | | | | | | |
| Photostabilizer | TINUVIN 292 | 2.0 | 2.0 | 2.0 | 2.0 | 2.0 | 2.0 | 2.0 | 2.0 |
| Catalyst | NEOSTANN U-830 | 0.6 | 0.6 | 0.6 | 0.6 | 0.6 | 0.6 | 0.6 | 0.6 |

| | | | | | | | | |
|---|---|---|---|---|---|---|---|---|
| Total | 100 | 100 | 100 | 100 | 100 | 100 | 100 | 100 |
| Solid content concentration (mass %) | 99 | 99 | 99 | 99 | 99 | 99 | 99 | 99 |

| | | | Example | | Comparative Example | | | | |
|---|---|---|---|---|---|---|---|---|---|
| | | | 24 | 25 | 1 | 2 | 3 | 4 | 5 |
| Coating composition No. | | | 24 | 25 | 26 | 27 | 28 | 29 | 30 |
| Isocyanate- | Hydroxyl | Desmophen XP2488 | 29.9 | | 34.7 | 94.6 | 28.0 | | |
| reactive | group- | Desmophen VPLS2249/1 | | | | | | | |
| group- | containing | (Note 1) | | | | | | | |
| containing | compound (A1) | Placcel 303 | | | | | | | |
| compound (A) | | (Note 2) | | | | | | | |
| | Amino | Desmophen NH1220 | | 41.4 | | | | | |
| | group- | (Note 3) | | | | | | | |
| | containing | Desmophen NH1423 | | 13.8 | | | | 39.9 | |
| | compound (A2) | (Note 4) | | | | | | | |
| | | CLEARLINK | | | | | | 13.4 | |
| | | 1000 (Note 5) | | | | | | | |
| | Thiol group- | TMMP-LV (Note 6) | | | | | | | 11.1 |
| | containing | TEMPIC (Note 7) | | | | | | | 33.6 |
| | compound | PEMP-LV (Note 8) | | | | | | | |
| | (A3) | | | | | | | | |
| Polyisocyanate | Desmodur N3900 | | 52.9 | 43.3 | 61.4 | | 49.7 | 42.9 | 51.3 |
| compound (B) | Desmodur N3400 (Note 9) | | | | | | | | |
| | Desmodur NZ200 (Note 10) | | | | | | | | |
| | Desmodur N3600 (Note 11) | | | | | | | | |
| Carbodiimide | Carbodilite V-05 | | 1.5 | 1.5 | | 1.5 | 1.5 | | |
| group- | Carbodiimide group- | | | | | | | | |
| containing | containing compound (C-1) | | | | | | | | |
| compound (C) | Carbodilite V-03 (Note 12) | | | | | | | | |
| | Carbodilite V-09M (Note 13) | | | | | | | | |
| Pigment | Color pigment | RAVEN 5000 | 1.0 | | | | 1.0 | | |
| dispersion | | ULTRA III POWDER | | | | | | | |
| liquid (P-1) | Pigment | SOLSPERSE 5000S | 0.1 | | | | 0.1 | | |
| | derivative | | | | | | | | |
| | Dispersant | DISPERBYK-2013 | 1.0 | | | | 1.0 | | |
| | Organic solvent | Butyl acetate | 4.7 | | | | 4.7 | | |

| | | | | | | | |
|---|---|---|---|---|---|---|---|
| Organic solvent | Butyl acetate | | | | 5.1 | | |
| | Ethyl 3-ethoxypropionate | 5.0 | | | 5.0 | | |
| Surface | BYK-333 | 0.1 | 0.1 | 0.1 | 0.1 | 0.1 | 0.1 |
| conditioner | | | | | | | |
| Ultraviolet | TINUVIN 400 | 1.2 | 1.2 | 1.2 | 1.2 | 1.2 | 1.2 |
| absorber | | | | | | | |
| Photostabilizer | TINUVIN 292 | 2.0 | 2.0 | 2.0 | 2.0 | 2.0 | 2.0 |
| Catalyst | NEOSTANN U-830 | 0.6 | 0.6 | 0.6 | 0.6 | 0.6 | 0.6 |

| | | | | | | | |
|---|---|---|---|---|---|---|---|
| Total | 100 | 100 | 100 | 100 | 100 | 100 | 100 |
| Solid content concentration (mass %) | 99 | 99 | 99 | 99 | 99 | 99 | 99 |

The components described in the tables are as follows.
(Note 1) “Desmophen VPLS 2249/1”: trade name, manufactured by Covestro AG, hydroxyl group-containing polyester resin comprising 44% of hydroxyl group-containing monomer, solid content concentration of 100%
(Note 2) “Placcel 303”: trade name, manufactured by Daicel Corporation, hydroxyl group-containing polycaprolactone resin, solid content concentration of 100%
(Note 3) “Desmophen NH1220”: trade name, manufactured by Covestro AG, tetraethyl N,N′-(2-methylpentane-1,5-diyl)bisaspartate, solid content concentration of 100%
(Note 4) “Desmophen NH1423”: trade name, manufactured by Covestro AG, tetraethyl N,N′-[methylenebis(cyclohexane-4,1-diyl)]bisaspartate, solid content concentration of 100%
(Note 5) “CLEARLINK 1000”: trade name, manufactured by Dorf Ketal Chemicals LLC, N,N′-di-sec-butyl-4,4′-methylenebis(cyclohexylamine), solid content concentration of 100%
(Note 6) “TMMP-LV”: trade name, manufactured by Sakai Chemical Industry Co., Ltd., trimethylolpropane tris(3-mercaptopropionate), solid content concentration of 100%
(Note 7) “TMPIC”: trade name, manufactured by Sakai Chemical Industry Co., Ltd., tris-[(3-mercaptopropionyloxy)-ethyl]isocyanurate, solid content concentration of 100%
(Note 8) “PEMP-LV”: trade name, manufactured by Sakai Chemical Industry Co., Ltd., pentaerythritol tetrakis(3-mercaptopropionate), solid content concentration of 100%
(Note 9) “Desmodur N3400”: trade name, manufactured by Sumika Covestro Urethane Co., Ltd., mixture of uretdione and isocyanurate of hexamethylene diisocyanate, solid content concentration of 100%
(Note 10) “Desmodur NZ200”: trade name, manufactured by Sumika Covestro Urethane Co., Ltd., mixture of isocyanurate of hexamethylene diisocyanate and isocyanurate of isophorone diisocyanate, solid content concentration of 100%
(Note 11) “Desmodur N3600”: trade name, manufactured by Sumika Covestro Urethane Co., Ltd., isocyanurate of hexamethylene diisocyanate, solid content concentration of 100%
(Note 12) “Carbodilite V-03”: manufactured by Nisshinbo Chemical Inc., carbodiimide group-containing compound free of an aromatic ring structure and an isocyanate group, carbodiimide equivalent per solid content of 216, number average molecular weight of 2000, solid content concentration of 50%
(Note 13) “Carbodilite V-09M”: Nisshinbo Chemical Inc., carbodiimide group-containing compound having an aromatic ring structure and free of an isocyanate group, carbodiimide equivalent per solid content of 200, number average molecular weight of 15000, solid content concentration of 70%

### Production of Test Coated Plate (T1)

### Example 26

“DIALAC TW20” (trade name, manufactured by Techno-UMG Co., Ltd., acrylonitrile-styrene-acrylate resin (ASA resin)) was first filled into an injection molding cylinder, and the “DIALAC TW20” was heat-melted at 230° C. The heat-melted “DIALAC TW20” was then injected between molds at 60° C., pressure was maintained for 30 s, and the “DIALAC TW20” was cooled. The solidified “DIALAC TW20” was then removed from the molds, and a flat “DIALAC TW20” substrate of 100 mm×100 mm×2 mm was obtained. The flat “DIALAC TW20” substrate surface was then degreased with isopropyl alcohol, and the flat “DIALAC TW20” substrate surface was coated thereon with the coating composition No. 1 obtained in Example 1 using an applicator, so as to have a cured film thickness of 100 μm, to form a coating film. The coating film was immediately cured by heating at 80° C. for 3 min, whereby a test coated plate (T1-1) was prepared.

### [Production of Test Coated Plate (T2)]

“Makroblend UT235M” (trade name, manufactured by Covestro AG, polymer alloy of polyethylene terephthalate resin and polycarbonate resin) was first filled in to an injection molding cylinder, and the “Makroblend UT235M” was heat-melted at 270° C. The heat-melted “Makroblend UT235M” was then injected between molds at 70° C., pressure was maintained for 30 s, and the “Makroblend UT235M” was cooled. The solidified “Makroblend UT235M” was then removed from the molds, and a flat “Makroblend UT235M” substrate of 100 mm×100 mm×2 mm was obtained. The flat “Makroblend UT235M” substrate surface was then degreased with isopropyl alcohol, and the flat “Makroblend UT235M” substrate surface was coated thereon with the coating composition No. 1 obtained in Example 1 using an applicator, so as to have a cured film thickness of 100 μm, to form a coating film. The coating film was immediately cured by heating at 80° C. for 3 min, whereby a test coated plate (T2-1) was prepared.

### Examples 27 to 50 and Comparative Examples 6 to 10

Test coated plates (T1-2) to (T1-30) and (T2-2) to (T2-30) were prepared in the same manner as in Example 26, except that the type of coating composition in Example 26 was changed as shown in Tables 2-1 and 2-2 below.

The obtained test coated plates were evaluated for water-resistant adhesion, hardness, and weather resistance. Evaluation results are shown in Tables 2-1 and 2-2.

### [Water-Resistant Adhesion]

Each of the test coated plates obtained in Examples 26 to 50 and Comparative Examples 6 to 10 was immersed in 40° C. warm water for 240 h, then raised, and dried at 20° C. for 24 h. The coating film of each of the test coated plates after the water resistance test was then cut into a lattice shape with a cutter so as to reach the base material, and 100 cross-hatch patterns in a size of 2 mm×2 mm were prepared. Adhesive cellophane tape was then attached to the surface of each of the cut test coated plates, and the adhesive cellophane tape was rapidly peeled off at a temperature of 23±2° C. and a relative humidity of 50±5% RH. The residual state of the cross-hatch pattern coating film after peeling was examined, and adhesion after the water resistance test was evaluated based on the criteria below. A, B, and C are acceptable.
A: 100 cross-hatch patterns remained on the coating film, and there were no small chips or lifting of the coating film at the edges of the cutter's notches.
B: 100 cross-hatch patterns remained on the coating film, but there were small chips or lifting of the coating film at the edges of the cutter's notches.
C: 90 to 99 cross-hatch patterns remained the coating film.
D: 80 to 89 cross-hatch patterns remained on the coating film.
E: 79 or less cross-hatch patterns remained on the coating film.

### [Hardness]

The Martens hardness (N/mm²) of each of the test coated plates obtained in Examples 26 to 50 and Comparative Examples 6 to 10 was measured using a “Fischerscope® HM2000S” (trade name, manufactured by Fischer Instruments K.K.), and was evaluated based on the criteria below.

The measurement conditions were: indenter: pyramidal Vickers indenter (material: diamond, facing angle: 136°), maximum test load: 20 mN, pressing speed: 20 mN/25 s, temperature: 21±2° C., and relative humidity: 50±5% RH. A, B, and C are acceptable.
A: Martens hardness was 125 N/mm² or more.
B: Martens hardness was 100 N/mm² or more and less than 125 N/mm²
C: Martens hardness was 75 N/mm² or more and less than 100 N/mm²
D: Martens hardness was 50 N/mm² or more and less than 75 N/mm²
E: Martens hardness was less than 50 N/mm²

### [Weather Resistance]

Each of the test coated plates obtained in Examples 26 to 50 and Comparative Examples 6 to 10 was irradiated with light from angles of 25°, 45°, and 75° relative to the axis perpendicular to the coating surface, using a multi-angle spectrophotometer “CM-512m3” (manufactured by Konica Minolta, Inc.), and the colors of L*, a*, and b* of the reflected light in a direction perpendicular to the coating surface were measured. An accelerated weather resistance test was then carried out using a “Super Xenon Weather Meter” (weather resistance tester, manufactured by Suga Test Instruments Co., Ltd.) under the conditions of test piece wetting cycle: 18 min/2 h, black panel temperature: 61 to 65° C., and lamp radiation time: 1,200 h, in accordance with JIS K 5600-7-7 (2008). Each of the test coated plates after the accelerated weather resistance test was then irradiated with light from angles of 25°, 45°, and 75° relative to the axis perpendicular to the coating surface, using a multi-angle spectrophotometer “CM-512m3” (manufactured by Konica Minolta, Inc.), and the colors of L*, a*, and b* of the reflected light in a direction perpendicular to the coating surface were measured. Next, ΔE*(25°), ΔE*(45°), and ΔE*(75°) at 25°, 45°, and 75°, respectively, were calculated in accordance with JIS K 5600-4-6 (1999) from the L*, a*, and b* colorimetric values before and after the accelerated weather resistance test, and the largest ΔE* value among ΔE*(25°), ΔE*(45°), and ΔE*(75°) was evaluated according to the following criteria. The smaller the ΔE*, the less discoloration of the test plate and the more satisfactory the weather resistance. A, B, and C are acceptable.
A: ΔE* was less than 1.0.
B: ΔE* was 1.0 or greater and less than 1.5.
C: ΔE* was 1.5 or greater and less than 2.0.
D: ΔE* was 2.0 or greater and less than 3.0.
E: ΔE* was 3.0 or greater.

TABLE 2-1

| | | | Example | | | | | | | | |
|---|---|---|---|---|---|---|---|---|---|---|---|
| | | | 26 | 27 | 28 | 29 | 30 | 31 | 32 | 33 | 34 |
| Coating composition No. | | | 1 | 2 | 3 | 4 | 5 | 6 | 7 | 8 | 9 |
| Solid content concentration (mass %) | | | 99 | 99 | 99 | 99 | 99 | 99 | 99 | 99 | 99 |
| Evaluation | Test | Test coated plate name | T1-1 | T1-2 | T1-3 | T1-4 | T1-5 | T1-6 | T1-7 | T1-8 | T1-9 |
| | coated | Water-resistant | A | A | B | C | B | A | A | B | A |
| | plate | adhesion | | | | | | | | | |
| | (T1) | Hardness | A | A | A | A | A | A | A | A | B |
| | | Weather resistance | A | A | A | A | A | A | A | A | A |
| | Test | Test coated | T2-1 | T2-2 | T2-3 | T2-4 | T2-5 | T2-6 | T2-7 | T2-8 | T2-9 |
| | coated | plate name | | | | | | | | | |
| | plate | Water-resistant | A | B | C | C | B | B | A | B | A |
| | (T2) | adhesion | | | | | | | | | |
| | | Hardness | A | A | A | A | A | A | A | A | B |
| | | Weather resistance | A | A | A | A | A | A | A | A | A |

| | | | Example | | | | | |
|---|---|---|---|---|---|---|---|---|
| | | | 35 | 36 | 37 | 38 | 39 | 40 |
| Coating composition No. | | | 10 | 11 | 12 | 13 | 14 | 15 |
| Solid content concentration (mass %) | | | 99 | 99 | 99 | 99 | 99 | 99 |
| Evaluation | Test | Test coated plate name | T1-10 | T1-11 | T1-12 | T1-13 | T1-14 | T1-15 |
| | coated | Water-resistant | A | A | A | A | A | A |
| | plate | adhesion | | | | | | |
| | (T1) | Hardness | A | C | A | B | A | B |
| | | Weather resistance | A | B | A | A | A | B |
| | Test | Test coated | T2-10 | T2-11 | T2-12 | T2-13 | T2-14 | T2-15 |
| | coated | plate name | | | | | | |
| | plate | Water-resistant | A | A | B | A | A | B |
| | (T2) | adhesion | | | | | | |
| | | Hardness | A | C | A | B | A | B |
| | | Weather resistance | A | B | A | A | A | B |

TABLE 2-2

| | | | Example | | | | | | | |
|---|---|---|---|---|---|---|---|---|---|---|
| | | | 41 | 42 | 43 | 44 | 45 | 46 | 47 | 48 |
| Coating composition No. | | | 16 | 17 | 18 | 19 | 20 | 21 | 22 | 23 |
| Solid content | | | 99 | 99 | 99 | 99 | 99 | 99 | 99 | 95 |
| concentration (mass %) | | | | | | | | | | |
| Evaluation | Test | Test coated | T1-16 | T1-17 | T1-18 | T1-19 | T1-20 | T1-21 | T1-22 | T1-23 |
| | coated | plate name | | | | | | | | |
| | plate | Water-resistant | B | A | A | A | A | A | A | A |
| | (T1) | adhesion | | | | | | | | |
| | | Hardness | B | A | A | B | B | A | A | A |
| | | Weather | B | A | A | A | A | B | A | A |
| | | resistance | | | | | | | | |
| | Test | Test coated | T2-16 | T2-17 | T2-18 | T2-19 | T2-20 | T2-21 | T2-22 | T2-23 |
| | coated | plate name | | | | | | | | |
| | plate | Water-resistant | C | B | A | A | B | A | A | A |
| | (T2) | adhesion | | | | | | | | |
| | | Hardness | B | A | A | B | B | A | A | A |
| | | Weather | B | A | A | A | A | B | A | A |
| | | resistance | | | | | | | | |

| | | | Example | | Comparative Example | | | | |
|---|---|---|---|---|---|---|---|---|---|
| | | | 49 | 50 | 6 | 7 | 8 | 9 | 10 |
| Coating composition No. | | | 24 | 25 | 26 | 27 | 28 | 29 | 30 |
| Solid content | | | 90 | 99 | 99 | 99 | 85 | 99 | 99 |
| concentration (mass %) | | | | | | | | | |
| Evaluation | Test | Test coated | T1-24 | T1-25 | T1-26 | T1-27 | T1-28 | T1-29 | T1-30 |
| | coated | plate name | | | | | | | |
| | plate | Water-resistant | A | A | D | E | A | E | E |
| | (T1) | adhesion | | | | | | | |
| | | Hardness | A | C | A | E | A | E | E |
| | | Weather | A | C | A | E | A | E | E |
| | | resistance | | | | | | | |
| | Test | Test coated | T2-24 | T2-25 | T2-26 | T2-27 | T2-28 | T2-29 | T2-30 |
| | coated | plate name | | | | | | | |
| | plate | Water-resistant | A | A | E | E | A | E | E |
| | (T2) | adhesion | | | | | | | |
| | | Hardness | A | C | A | E | A | E | E |
| | | Weather | A | C | A | E | A | E | E |
| | | resistance | | | | | | | |

### Production of in-Mold Coating Composition

### Example 51

33.9 parts of “Desmophen XP2488” (trade name, manufactured by Covestro AG, hydroxyl group-containing polyester resin comprising 26% hydroxyl group-containing monomer, solid content concentration of 100%), 60.1 parts of “Desmodur N3900” (trade name, manufactured by Sumika Covestro Urethane Co., Ltd., iminooxadiazinedione of hexamethylene diisocyanate, solid content concentration of 100%), 1.5 parts of “Carbodilite V-05” (trade name, manufactured by Nisshinbo Chemical Inc., carbodiimide group-containing compound having an aromatic ring structure and two isocyanate groups, carbodiimide equivalent per solid content of 262, number average molecular weight of 800, solid content concentration of 100%), 0.6 parts of “Moldwiz INT-120IMC” (trade name, manufactured by Axel Plastics Research Laboratory, Inc., fatty acid tertiary dimethylamide-containing mixture, solid content concentration of 100%), 0.1 parts of “BYK-333” (trade name, manufactured by BYK-Chemie, surface conditioner (polyether-modified polydimethylsiloxane), solid content concentration of 100%), 1.2 parts of “TINUVIN 400” (trade name, manufactured by BASF SE, triazine-based ultraviolet absorber, solid content concentration of 85%), 2.0 parts of “TINUVIN 292” (trade name, manufactured by BASF SE, photostabilizer of hindered amine compound, solid content concentration of 100%), and 0.6 parts of “NEOSTANN U-830” (trade name, manufactured by Nitto Kasei Co., Ltd., dioctyltin diversatate, solid content concentration of 100%) were blended in a container equipped with a stirring apparatus, and the contents of the container were uniformly mixed to obtain an in-mold coating composition No. 1 having a solid content concentration of 99%.

### Examples 52 to 85 and Comparative Examples 11 to 15

In-mold coating compositions No. 2 to No. 40 were obtained in the same manner as in Example 51, except that the blending composition in Example 51 was changed to those shown in Tables 3-1 and 3-2 below.

[Evaluation of in-Mold Coating Composition]

The obtained in-mold coating compositions were evaluated for transparency. Evaluation results are shown in Tables 3-1 and 3-2.

### [Transparency]

A transparent glass plate, which had the total light transmittance thereof measured in advance using a “Color and Turbidity Simultaneous Measurement device COH 400” (trade name, manufactured by Nippon Denshoku Industries Co., Ltd., haze meter), was coated thereon with one of the in-mold coating compositions obtained in Examples 51 to 85 and Comparative Examples 11 to 15 using an applicator, so as to have a cured film thickness of 210±20 μm, to form a coating film. The coating film was immediately cured by heating at 80° C. for 3 min to obtain a coated plate for transparency test. The total light transmittance of the obtained coated plate for transparency test was measured using a “Color and Turbidity Simultaneous Measurement device COH 400” (trade name, manufactured by Nippon Denshoku Industries Co., Ltd., haze meter), and from the total light transmittance of the coated plate for transparency test, the total light transmittance of the transparent glass plate was subtracted to determine the total light transmittance of the coating film, which was evaluated based on the criteria below. A, B, and C are acceptable.
A: Total light transmittance was 90% or greater.
B: Total light transmittance was 88% or greater and less than 90%.
C: Total light transmittance was 86% or greater and less than 88%.
D: Total light transmittance was 84% or greater and less than 86%.
E: Total light transmittance was less than 84%.

TABLE 3-1

| | | | Example | | | | | | | | | |
|---|---|---|---|---|---|---|---|---|---|---|---|---|
| | | | 51 | 52 | 53 | 54 | 55 | 56 | 57 | 58 | 59 | 60 |
| In-mold coating composition No. | | | 1 | 2 | 3 | 4 | 5 | 6 | 7 | 8 | 9 | 10 |
| Isocyanate- | Hydroxyl | Desmophen | 33.9 | 33.9 | 33.4 | 34.4 | 34.3 | 32.7 | 32.3 | 27.3 | 27.1 | 32.3 |
| reactive | group- | XP2488 | | | | | | | | | | |
| group- | containing | Desmophen VPLS2249/1 | | | | | | | | 6.8 | | |
| containing | compound | (Note 1) | | | | | | | | | | |
| compound (A) | (A1) | Placcel 303 | | | | | | | | | 6.8 | |
| | | (Note 2) | | | | | | | | | | |
| | Amino | Desmophen NH1220 | | | | | | | | | | |
| | group- | (Note 3) | | | | | | | | | | |
| | containing | Desmophen NH1423 | | | | | | | | | | |
| | compound | (Note 4) | | | | | | | | | | |
| | (A2) | CLEARLINK | | | | | | | | | | |
| | | 1000 (Note 5) | | | | | | | | | | |
| | Thiol | TMMP-LV (Note 6) | | | | | | | | | | |
| | group- | TEMPIC (Note 7) | | | | | | | | | | |
| | containing | PEMP-LV (Note 8) | | | | | | | | | | |
| | compound | | | | | | | | | | | |
| | (A3) | | | | | | | | | | | |
| Polyisocyanate | Desmodur N3900 | | 60.1 | 60.1 | 59.1 | 60.9 | 60.7 | 57.9 | 57.2 | 60.0 | 60.2 | |
| compound | Desmodur N3400 (Note 9) | | | | | | | | | | | 61.7 |
| (B) | Desmodur NZ200 (Note 10) | | | | | | | | | | | |
| | Desmodur N3600 (Note 11) | | | | | | | | | | | |
| Carbodiimide | Carbodilite V-05 | | 1.5 | | | 0.3 | 0.5 | 5.0 | 6.0 | 1.5 | 1.5 | 1.5 |
| group- | Carbodiimide group- | | | 1.5 | | | | | | | | |
| containing | containing compound (C-1) | | | | | | | | | | | |
| compound (C) | Carbodilite V-03 (Note 12) | | | | 3.0 | | | | | | | |
| Internal | Moldwiz INT-120IMC | | 0.6 | 0.6 | 0.6 | 0.6 | 0.6 | 0.6 | 0.6 | 0.6 | 0.6 | 0.6 |
| release agent | Amide AP-1 (Note 14) | | | | | | | | | | | |
| (D) | NEUTRON PNT-34 (Note 15) | | | | | | | | | | | |
| | N,N-diethylstearamide | | | | | | | | | | | |
| | METHYL STEARATE 95 (Note 16) | | | | | | | | | | | |
| | DAIFREE FB-962 (Note 17) | | | | | | | | | | | |
| | NEWPOL 50HB-5100 (Note 18) | | | | | | | | | | | |
| Pigment | Color | RAVEN 5000 ULTRA | | | | | | | | | | |
| dispersion | pigment | III POWDER | | | | | | | | | | |
| liquid (P-1) | Pigment | SOLSPERSE 5000S | | | | | | | | | | |
| | derivative | | | | | | | | | | | |
| | Dispersant | DISPERBYK-2013 | | | | | | | | | | |
| | Organic | Butyl acetate | | | | | | | | | | |
| | solvent | | | | | | | | | | | |
| Organic | Butyl acetate | | | | | | | | | | | |
| solvent | Ethyl 3-ethoxypropionate | | | | | | | | | | | |
| Surface | BYK-333 | | 0.1 | 0.1 | 0.1 | 0.1 | 0.1 | 0.1 | 0.1 | 0.1 | 0.1 | 0.1 |
| conditioner | | | | | | | | | | | | |
| Ultraviolet | TINUVIN 400 | | 1.2 | 1.2 | 1.2 | 1.2 | 1.2 | 1.2 | 1.2 | 1.2 | 1.2 | 1.2 |
| absorber | | | | | | | | | | | | |
| Photostabilizer | TINUVIN 292 | | 2.0 | 2.0 | 2.0 | 2.0 | 2.0 | 2.0 | 2.0 | 2.0 | 2.0 | 2.0 |
| Catalyst | NEOSTANN U-830 | | 0.6 | 0.6 | 0.6 | 0.6 | 0.6 | 0.6 | 0.6 | 0.6 | 0.6 | 0.6 |
| Total | | | 100 | 100 | 100 | 100 | 100 | 100 | 100 | 100 | 100 | 100 |
| Solid content concentration (mass %) | | | 99 | 99 | 98 | 99 | 99 | 99 | 99 | 99 | 99 | 99 |
| Evaluation | Coating film transparency | | A | A | A | A | A | A | A | A | A | A |
| | | | Example | | | | | | | | | |
| | | | 61 | 62 | 63 | 64 | 65 | 66 | 67 | 68 | 69 | 70 |
| In-mold coating composition No. | | | 11 | 12 | 13 | 14 | 15 | 16 | 17 | 18 | 19 | 20 |
| Isocyanate- | Hydroxyl | Desmophen | 31.6 | 26.9 | 33.0 | | | | 28.4 | | | |
| reactive | group- | XP2488 | | | | | | | | | | |
| group- | containing | Desmophen VPLS2249/1 | | 6.8 | | | | | | | | |
| containing | compound | (Note 1) | | | | | | | | | | |
| compound (A) | (A1) | Placcel 303 | | | | | | | | | | |
| | | (Note 2) | | | | | | | | | | |
| | Amino | Desmophen NH1220 | | | | 39.5 | 39.5 | | | | | |
| | group- | (Note 3) | | | | | | | | | | |
| | containing | Desmophen NH1423 | | | | 13.2 | 13.2 | 39.0 | | | | |
| | compound | (Note 4) | | | | | | | | | | |
| | (A2) | CLEARLINK | | | | | | 13.1 | 7.1 | | | |
| | | 1000 (Note 5) | | | | | | | | | | |
| | Thiol | TMMP-LV (Note 6) | | | | | | | | 10.9 | 10.9 | |
| | group- | TEMPIC (Note 7) | | | | | | | | 32.9 | 32.9 | 32.4 |
| | containing | PEMP-LV (Note 8) | | | | | | | | | | 10.8 |
| | compound | | | | | | | | | | | |
| | (A3) | | | | | | | | | | | |
| Polyisocyanate | Desmodur N3900 | | | | 32.7 | 41.4 | 41.4 | 41.9 | 58.5 | 50.2 | 50.2 | 50.8 |
| compound | Desmodur N3400 (Note 9) | | | | 8.0 | | | | | | | |
| (B) | Desmodur NZ200 (Note 10) | | 62.4 | | 20.3 | | | | | | | |
| | Desmodur N3600 (Note 11) | | | 60.4 | | | | | | | | |
| Carbodiimide | Carbodilite V-05 | | 1.5 | 1.5 | 1.5 | 1.5 | | 1.5 | 1.5 | 1.5 | | 1.5 |
| group- | Carbodiimide group- | | | | | | 1.5 | | | | 1.5 | |
| containing | containing compound (C-1) | | | | | | | | | | | |
| compound (C) | Carbodilite V-03 (Note 12) | | | | | | | | | | | |
| Internal | Moldwiz INT-120IMC | | 0.6 | 0.6 | 0.6 | 0.6 | 0.6 | 0.6 | 0.6 | 0.6 | 0.6 | 0.6 |
| release agent | Amide AP-1 (Note 14) | | | | | | | | | | | |
| (D) | NEUTRON PNT-34 (Note 15) | | | | | | | | | | | |
| | N,N-diethylstearamide | | | | | | | | | | | |
| | METHYL STEARATE 95 (Note 16) | | | | | | | | | | | |
| | DAIFREE FB-962 (Note 17) | | | | | | | | | | | |
| | NEWPOL 50HB-5100 (Note 18) | | | | | | | | | | | |
| Pigment | Color | RAVEN 5000 ULTRA | | | | | | | | | | |
| dispersion | pigment | III POWDER | | | | | | | | | | |
| liquid (P-1) | Pigment | SOLSPERSE 5000S | | | | | | | | | | |
| | derivative | | | | | | | | | | | |
| | Dispersant | DISPERBYK-2013 | | | | | | | | | | |
| | Organic | Butyl acetate | | | | | | | | | | |
| | solvent | | | | | | | | | | | |

| Organic | Butyl acetate | | | | | | | | | | |
|---|---|---|---|---|---|---|---|---|---|---|---|
| solvent | Ethyl 3-ethoxypropionate | | | | | | | | | | |
| Surface | BYK-333 | 0.1 | 0.1 | 0.1 | 0.1 | 0.1 | 0.1 | 0.1 | 0.1 | 0.1 | 0.1 |
| conditioner | | | | | | | | | | | |
| Ultraviolet | TINUVIN 400 | 1.2 | 1.2 | 1.2 | 1.2 | 1.2 | 1.2 | 1.2 | 1.2 | 1.2 | 1.2 |
| absorber | | | | | | | | | | | |
| Photostabilizer | TINUVIN 292 | 2.0 | 2.0 | 2.0 | 2.0 | 2.0 | 2.0 | 2.0 | 2.0 | 2.0 | 2.0 |
| Catalyst | NEOSTANN U-830 | 0.6 | 0.6 | 0.6 | 0.6 | 0.6 | 0.6 | 0.6 | 0.6 | 0.6 | 0.6 |
| Total | | 100 | 100 | 100 | 100 | 100 | 100 | 100 | 100 | 100 | 100 |
| Solid content concentration (mass %) | | 99 | 99 | 99 | 99 | 99 | 99 | 99 | 99 | 99 | 99 |
| Evaluation | Coating film transparency | A | A | A | C | C | C | B | A | A | A |

TABLE 3-2

| | | | Example | | | | | | | | | |
|---|---|---|---|---|---|---|---|---|---|---|---|---|
| | | | 71 | 72 | 73 | 74 | 75 | 76 | 77 | 78 | 79 | 80 |
| In-mold coating composition No. | | | 21 | 22 | 23 | 24 | 25 | 26 | 27 | 28 | 29 | 30 |
| Isocyanate- | Hydroxyl | Desmophen | 28.0 | 33.9 | 33.9 | 33.9 | 33.9 | 33.9 | 33.9 | 34.1 | 34.0 | 33.6 |
| reactive | group- | XP2488 | | | | | | | | | | |
| group- | containing | Desmophen VPLS2249/1 | | | | | | | | | | |
| containing | compound | (Note 1) | | | | | | | | | | |
| compound (A) | (A1) | Placcel 303 | | | | | | | | | | |
| | | (Note 2) | | | | | | | | | | |
| | Amino group- | Desmophen NH1220 | | | | | | | | | | |
| | containing | (Note 3) | | | | | | | | | | |
| | compound | Desmophen NH1423 | | | | | | | | | | |
| | (A2) | (Note 4) | | | | | | | | | | |
| | | CLEARLINK | | | | | | | | | | |
| | | 1000 (Note 5) | | | | | | | | | | |
| | Thiol group- | TMMP-LV (Note 6) | 7.0 | | | | | | | | | |
| | containing | TEMPIC (Note 7) | | | | | | | | | | |
| | compound | PEMP-LV (Note 8) | | | | | | | | | | |
| | (A3) | | | | | | | | | | | |
| Polyisocyanate | Desmodur N3900 | | 59.1 | 60.1 | 60.1 | 60.1 | 60.1 | 60.1 | 60.1 | 60.3 | 60.2 | 59.5 |
| compound | Desmodur N3400 (Note 9) | | | | | | | | | | | |
| (B) | Desmodur NZ200 (Note 10) | | | | | | | | | | | |
| | Desmodur N3600 (Note 11) | | | | | | | | | | | |
| Carbodiimide | Carbodilite V-05 | | 1.5 | 1.5 | 1.5 | 1.5 | 1.5 | 1.5 | 1.5 | 1.5 | 1.5 | 1.5 |
| group- | Carbodiimide group- | | | | | | | | | | | |
| containing | containing compound (C-1) | | | | | | | | | | | |
| compound (C) | Carbodilite V-03 (Note 12) | | | | | | | | | | | |
| Internal | Moldwiz INT-120IMC | | 0.6 | | | | | | | 0.2 | 0.4 | 1.5 |
| release agent | Amide AP-1 (Note 14) | | | 0.6 | | | | | | | | |
| (D) | NEUTRON PNT-34 (Note 15) | | | | 0.6 | | | | | | | |
| | N,N-diethylstearamide | | | | | 0.6 | | | | | | |
| | METHYL STEARATE 95 (Note 16) | | | | | | 0.6 | | | | | |
| | DAIFREE FB-962 (Note 17) | | | | | | | 0.6 | | | | |
| | NEWPOL 50HB-5100 (Note 18) | | | | | | | | 0.6 | | | |
| Pigment | Color pigment | RAVEN 5000 ULTRA | | | | | | | | | | |
| dispersion | | III POWDER | | | | | | | | | | |
| liquid (P-1) | Pigment | SOLSPERSE 5000S | | | | | | | | | | |
| | derivative | | | | | | | | | | | |
| | Dispersant | DISPERBYK-2013 | | | | | | | | | | |
| | Organic | Butyl acetate | | | | | | | | | | |
| | solvent | | | | | | | | | | | |
| Organic | Butyl acetate | | | | | | | | | | | |
| solvent | Ethyl 3-ethoxypropionate | | | | | | | | | | | |
| Surface | BYK-333 | | 0.1 | 0.1 | 0.1 | 0.1 | 0.1 | 0.1 | 0.1 | 0.1 | 0.1 | 0.1 |
| conditioner | | | | | | | | | | | | |
| Ultraviolet | TINUVIN 400 | | 1.2 | 1.2 | 1.2 | 1.2 | 1.2 | 1.2 | 1.2 | 1.2 | 1.2 | 1.2 |
| absorber | | | | | | | | | | | | |
| Photostabilizer | TINUVIN 292 | | 2.0 | 2.0 | 2.0 | 2.0 | 2.0 | 2.0 | 2.0 | 2.0 | 2.0 | 2.0 |
| Catalyst | NEOSTANN U-830 | | 0.6 | 0.6 | 0.6 | 0.6 | 0.6 | 0.6 | 0.6 | 0.6 | 0.6 | 0.6 |
| Total | | | 100 | 100 | 100 | 100 | 100 | 100 | 100 | 100 | 100 | 100 |
| Solid content concentration (mass %) | | | 99 | 99 | 99 | 99 | 99 | 99 | 99 | 99 | 99 | 99 |
| Evaluation | Coating film transparency | | A | D | E | A | A | E | A | A | A | C |
| | | | Example | | | | | Comparative Example | | | | |
| | | | 81 | 82 | 83 | 84 | 85 | 11 | 12 | 13 | 14 | 15 |
| In-mold coating composition No. | | | 31 | 32 | 33 | 34 | 35 | 36 | 37 | 38 | 39 | 40 |
| Isocyanate- | Hydroxyl | Desmophen | 33.4 | 34.2 | 31.5 | 29.7 | | 34.5 | 94.0 | 27.7 | | |
| reactive | group- | XP2488 | | | | | | | | | | |
| group- | containing | Desmophen VPLS2249/1 | | | | | | | | | | |
| containing | compound | (Note 1) | | | | | | | | | | |
| compound (A) | (A1) | Placcel 303 | | | | | | | | | | |
| | | (Note 2) | | | | | | | | | | |
| | Amino group- | Desmophen NH1220 | | | | | 41.1 | | | | | |
| | containing | (Note 3) | | | | | | | | | | |
| | compound | Desmophen NH1423 | | | | | 13.7 | | | | 39.6 | |
| | (A2) | (Note 4) | | | | | | | | | | |
| | | CLEARLINK | | | | | | | | | 13.3 | |
| | | 1000 (Note 5) | | | | | | | | | | |
| | Thiol group- | TMMP-LV (Note 6) | | | | | | | | | | 11.1 |
| | containing | TEMPIC (Note 7) | | | | | | | | | | 33.4 |
| | compound | PEMP-LV (Note 8) | | | | | | | | | | |
| | (A3) | | | | | | | | | | | |
| Polyisocyanate | Desmodur N3900 | | 59.2 | 60.4 | 55.7 | 52.5 | 43.1 | 61.0 | | 49.4 | 42.6 | 51.0 |
| compound | Desmodur N3400 (Note 9) | | | | | | | | | | | |
| (B) | Desmodur NZ200 (Note 10) | | | | | | | | | | | |
| | Desmodur N3600 (Note 11) | | | | | | | | | | | |
| Carbodiimide | Carbodilite V-05 | | 1.5 | 1.5 | 1.5 | 1.5 | 1.5 | | 1.5 | 1.5 | | |
| group- | Carbodiimide group- | | | | | | | | | | | |
| containing | containing compound (C-1) | | | | | | | | | | | |
| compound (C) | Carbodilite V-03 (Note 12) | | | | | | | | | | | |
| Internal | Moldwiz INT-120IMC | | 2 | | 0.6 | 0.6 | 0.6 | 0.6 | 0.6 | 0.6 | 0.6 | 0.6 |
| release agent | Amide AP-1 (Note 14) | | | | | | | | | | | |
| (D) | NEUTRON PNT-34 (Note 15) | | | | | | | | | | | |
| | N,N-diethylstearamide | | | | | | | | | | | |
| | METHYL STEARATE 95 (Note 16) | | | | | | | | | | | |
| | DAIFREE FB-962 (Note 17) | | | | | | | | | | | |
| | NEWPOL 50HB-5100 (Note 18) | | | | | | | | | | | |
| Pigment | Color pigment | RAVEN 5000 ULTRA | | | 1.0 | 1.0 | | | | 1.0 | | |
| dispersion | | III POWDER | | | | | | | | | | |
| liquid (P-1) | Pigment | SOLSPERSE 5000S | | | 0.1 | 0.1 | | | | 0.1 | | |
| | derivative | | | | | | | | | | | |
| | Dispersant | DISPERBYK-2013 | | | 1.0 | 1.0 | | | | 1.0 | | |
| | Organic | Butyl acetate | | | 4.7 | 4.7 | | | | 4.7 | | |
| | solvent | | | | | | | | | | | |

| Organic | Butyl acetate | | | | | | | | 5.1 | | |
|---|---|---|---|---|---|---|---|---|---|---|---|
| solvent | Ethyl 3-ethoxypropionate | | | | 5.0 | | | | 5.0 | | |
| Surface | BYK-333 | 0.1 | 0.1 | 0.1 | 0.1 | | 0.1 | 0.1 | 0.1 | 0.1 | 0.1 |
| conditioner | | | | | | | | | | | |
| Ultraviolet | TINUVIN 400 | 1.2 | 1.2 | 1.2 | 1.2 | | 1.2 | 1.2 | 1.2 | 1.2 | 1.2 |
| absorber | | | | | | | | | | | |
| Photostabilizer | TINUVIN 292 | 2.0 | 2.0 | 2.0 | 2.0 | | 2.0 | 2.0 | 2.0 | 2.0 | 2.0 |
| Catalyst | NEOSTANN U-830 | 0.6 | 0.6 | 0.6 | 0.6 | | 0.6 | 0.6 | 0.6 | 0.6 | 0.6 |
| Total | | 100 | 100 | 100 | 100 | 100 | 100 | 100 | 100 | 100 | 100 |
| Solid content concentration (mass %) | | 99 | 99 | 95 | 90 | 99 | 99 | 99 | 85 | 99 | 99 |
| Evaluation | Coating film transparency | D | A | A | A | A | A | E | A | E | E |

The components described in the tables are as follows.
(Note 14) “Amide AP-1”: trade name, manufactured by Mitsubishi Chemical Corporation, stearic acid amide, solid content concentration of 100%
(Note 15) “NEUTRON PNT-34”: trade name, manufactured by Nippon Fine Chemical Co., Ltd., N-oleyl palmitic acid amide, solid content concentration of 100%
(Note 16) “METHYL STEARATE 95”: trade name, manufactured by NOF Corporation, methyl stearate, solid content concentration of 100%
(Note 17) “DAIFREE DB-962”: trade name, manufactured by Daikin Industries, Ltd., fluorine-based polymer, solid content concentration of 100%
(Note 18) “NEWPOL 50HB-5100”: trade name, manufactured by Sanyo Chemical Industries, Ltd., polyoxyalkylene ether-based oligomer, solid content concentration of 100%

### Production of in-Mold Coated Molding (M1)

### Example 86

“DIALAC TW20” (trade name, manufactured by Techno-UMG Co., Ltd., acrylonitrile-styrene-acrylate resin (ASA resin)) was first filled into an injection molding cylinder, and the “DIALAC TW20” was heat-melted at 230° C. The heat-melted “DIALAC TW20” was then injected between resin-molding molds at 60° C., pressure was maintained for 30 s, and the “DIALAC TW20” was cooled. The solidified “DIALAC TW20” was then removed from the molds, and a flat “DIALAC TW20” molded article of 100 mm×100 mm×2 mm was obtained. The resin-molding molds were opened once, and the in-mold coating composition No. 1 obtained in Example 51 was injected between the obtained flat “DIALAC TW20” molded article and the coating film-coated molds. The inside of the coating film-coated molds were heated to 80° C. and the temperature was maintained, a molding pressure of 5 MPa was applied and maintained for 1 min, the pressure was then reduced, and the coating film-coated molds were opened to prepare an in-mold coated molding (M1-1) coated with a coating film at a cured film thickness of 200 m on the flat “DIALAC TW20” molded article.

[Production of in-Mold Coated Molding (M2)]

“Makroblend UT235M” (trade name, manufactured by Covestro AG, polymer alloy of polyethylene terephthalate resin and polycarbonate resin) was first filled into an injection molding cylinder, and the “Makroblend UT235M” was heat-melted at 270° C. The heat-melted “Makroblend UT235M” was then injected between resin-molding molds at 70° C., pressure was maintained for 30 s, and the “Makroblend UT235M” was cooled. The solidified “Makroblend UT235M” was then removed from the molds, and a flat “Makroblend UT235M” molded article of 100 mm×100 mm×2 mm was obtained. The resin-molding molds were opened once, and the in-mold coating composition No. 1 obtained in Example 51 was injected between the obtained flat “Makroblend UT235M” molded article and the coating film-coated molds. The inside of the coating film-coated molds were heated to 80° C. and the temperature was maintained, a molding pressure of 5 MPa was applied and maintained for 1 min, the pressure was then reduced, and the coating film-coated molds were opened to prepare an in-mold coated molding (M2-1) coated with a coating film at a cured film thickness of 200 μm on the flat “Makroblend UT235M” molded article.

### Examples 87 to 120 and Comparative Examples 16 to 20

In-mold coated moldings (M1-2) to (M1-40) and (M2-2) to (M2-40) were prepared in the same manner as in Example 86, except that the type of coating composition in Example 86 was changed as shown in Tables 4-1 and 4-2 below.

[Evaluation of in-Mold Coated Molding]

The cured coating film on each of the obtained in-mold coated moldings was evaluated for water-resistant adhesion, hardness, weather resistance, pinhole resistance, and mold releasability. Evaluation results are shown in Tables 4-1 and 4-2.

### [Water-Resistant Adhesion]

Each of the in-mold coated moldings obtained in Examples 86 to 120 and Comparative Examples 16 to 20 was immersed in 40° C. warm water for 240 h, then raised, and dried at 20° C. for 24 h. The coating film of each of the in-mold coated moldings after the water resistance test was then cut into a lattice shape with a cutter so as to reach the base material, and 100 cross-hatch patterns in a size of 2 mm×2 mm were prepared. Adhesive cellophane tape was then attached to the surface of each of the cut test coated plates, and the adhesive cellophane tape was rapidly peeled off at a temperature of 23±2° C. and a relative humidity of 50±5% RH. The residual state of the cross-hatch pattern coating film after peeling was examined, and adhesion after the water resistance test was evaluated based on the criteria below. A, B, and C are acceptable.
A: 100 cross-hatch patterns remained on the coating film, and there were no small chips or lifting of the coating film at the edges of the cutter's notches.
B: 100 cross-hatch patterns remained on the coating film, but there were small chips or lifting of the coating film at the edges of the cutter's notches.
C: 90 to 99 cross-hatch patterns remained the coating film.
D: 80 to 89 cross-hatch patterns remained on the coating film.
E: 79 or less cross-hatch patterns remained on the coating film.

### [Hardness]

The Martens hardness (N/mm²) of the cured coating film on each of the in-mold coated moldings obtained in Examples 86 to 120 and Comparative Examples 16 to 20 was measured using a “Fischerscope® HM2000S” (trade name, manufactured by Fischer Instruments K.K.), and was evaluated based on the criteria below. The measurement conditions were: indenter: pyramidal Vickers indenter (material: diamond, facing angle: 136°), maximum test load: 20 mN, pressing speed: 20 mN/25 s, temperature: 21±2° C., and relative humidity: 50±5% RH. A, B, and C are acceptable.
A: Martens hardness was 125 N/mm² or more.
B: Martens hardness was 100 N/mm² or more and less than 125 N/mm²
C: Martens hardness was 75 N/mm² or more and less than 100 N/mm²
D: Martens hardness was 50 N/mm² or more and less than 75 N/mm²
E: Martens hardness was less than 50 N/mm²

### [Weather Resistance]

Each of the in-mold coated moldings obtained in Examples 86 to 120 and Comparative Examples 16 to 20 was irradiated with light from angles of 25°, 45°, and 750 relative to the axis perpendicular to the coating surface, using a multi-angle spectrophotometer “CM-512m3” (manufactured by Konica Minolta, Inc.), and the colors of L*, a*, and b* of the reflected light in a direction perpendicular to the coating surface were measured. An accelerated weather resistance test was then carried out using a “Super Xenon Weather Meter” (weather resistance tester, manufactured by Suga Test Instruments Co., Ltd.) under the conditions of test piece wetting cycle: 18 min/2 h, black panel temperature: 61 to 65° C., and lamp radiation time: 1,200 h, in accordance with JIS K 5600-7-7 (2008). Each of the in-mold coated moldings after the accelerated weather resistance test was then irradiated with light from angles of 25°, 45°, and 750 relative to the axis perpendicular to the coating surface, using a multi-angle spectrophotometer “CM-512m3” (manufactured by Konica Minolta, Inc.), and the colors of L*, a*, and b* of the reflected light in a direction perpendicular to the coating surface were measured. Next, ΔE*(25°), ΔE*(45°), and ΔE*(75°) at 25°, 45°, and 75°, respectively, were calculated in accordance with JIS K 5600-4-6 (1999) from the L*, a*, and b* colorimetric values before and after the accelerated weather resistance test, and the largest ΔE* value among ΔE*(25°), ΔE*(45°), and ΔE*(75°) was evaluated according to the following criteria. The smaller the ΔE*, the less discoloration of the coating film and the more satisfactory the weather resistance.
A, B, and C are acceptable.
A: ΔE* was less than 1.0.
B: ΔE* was 1.0 or greater and less than 1.5.
C: ΔE* was 1.5 or greater and less than 2.0.
D: ΔE* was 2.0 or greater and less than 3.0.
E: ΔE* was 3.0 or greater.

### [Pinhole Resistance]

Each of the in-mold coated moldings obtained in Examples 86 to 120 and Comparative Examples 16 to 20 was observed with the naked eye, the number of pinholes generated on the coating film surface on the in-mold coated molding was counted, and pinhole resistance was evaluated according to the following criteria. A, B, and C are acceptable.
A: On the in-mold coated molding, there were no pinholes of 1 mm or more, and there were 3 or less pinholes of less than 1 mm.
B: On the in-mold coated molding, there were no pinholes of 1 mm or more, and there were 4 to 6 pinholes of less than 1 mm.
C: On the in-mold coated molding, there were no pinholes of 1 mm or more, and there were 7 or more pinholes of less than 1 mm.
D: On the in-mold coated molding, there were 1 to 3 pinholes of 1 mm or more.
E: On the in-mold coated molding, there were 4 or more pinholes of 1 mm or more.

### [Mold Releasability]

In the preparation of the above in-mold coated moldings (M1) and (M2), when the coating film-coated mold was released, a mold release test, wherein a spatula was inserted into a gap between one of the four corners of the in-mold coated molding and the coating film-coated mold and lifted up to release the in-mold coated molding from the coating film-coated mold, was carried out. If the in-mold coating composition could not be released, the spatula was removed, reinserted into a gap between one of the four corners to the right and the coating film-coated mold, and lifted up in the same manner to carry out the mold release test. The mold release test was carried out at all four corners until the in-mold coating composition was released from the mold, up to a total of four times. For the in-mold coated moldings where peeling of a coating film was observed, the surface of the in-mold coated molding was observed with the naked eye, the number of coating film peelings was counted, and mold releasability was evaluated according to the following criteria.
A, B, and C are acceptable.
A: The in-mold coated molding was released from the mold in the first or second mold release test, and the number of coating film peelings was 0.
B: The in-mold coated molding was released from the mold in the third or fourth mold release test, and the number of coating film peelings was 0.
C: The in-mold coated molding was released from the mold between the first and fourth mold release test, and the number of coating film peelings was 1.
D: The in-mold coated molding was released from the mold between the first and fourth mold release test, and the number of coating film peelings was 2 or more.
E: The in-mold coated molding was not released from the mold even after carrying out the mold release test 4 times, or the coating film was completely peeled off from the substrate.

TABLE 4-1

| | | | Example | | | | | | | | | |
|---|---|---|---|---|---|---|---|---|---|---|---|---|
| | | | 86 | 87 | 88 | 89 | 90 | 91 | 92 | 93 | 94 | 95 |
| In-mold coating composition No. | | | 1 | 2 | 3 | 4 | 5 | 6 | 7 | 8 | 9 | 10 |
| Solid content concentration | | | 99 | 99 | 99 | 99 | 99 | 99 | 99 | 99 | 99 | 99 |
| (mass %) | | | | | | | | | | | | |
| Evaluation | In-mold | In-mold coated | M1-1 | M1-2 | M1-3 | M1-4 | M1-5 | M1-6 | M1-7 | M1-8 | M1-9 | M1- |
| | coated | molding name | | | | | | | | | | 10 |
| | molding | Water-resistant | A | A | B | B | A | A | B | A | A | A |
| | (M1) | adhesion | | | | | | | | | | |
| | | Hardness | A | A | A | A | A | A | A | B | A | C |
| | | Weather | A | A | A | A | A | A | A | A | A | B |
| | | resistance | | | | | | | | | | |
| | | Pinhole | A | A | A | A | A | A | A | A | A | A |
| | | resistance | | | | | | | | | | |
| | | Mold | A | A | A | A | A | A | A | A | A | A |
| | | releasability | | | | | | | | | | |
| | In-mold | In-mold coated | M2-1 | M2-2 | M2-3 | M2-4 | M2-5 | M2-6 | M2-7 | M2-8 | M2-9 | M2- |
| | coated | molding name | | | | | | | | | | 10 |
| | molding | Water-resistant | A | B | C | B | B | A | B | A | A | A |
| | (M2) | adhesion | | | | | | | | | | |
| | | Hardness | A | A | A | A | A | A | A | B | A | C |
| | | Weather | A | A | A | A | A | A | A | A | A | B |
| | | resistance | | | | | | | | | | |
| | | Pinhole | A | A | A | A | A | A | A | A | A | A |
| | | resistance | | | | | | | | | | |
| | | Mold | A | A | A | A | A | A | A | A | A | A |
| | | releasability | | | | | | | | | | |
| | | | Example | | | | | | | | | |
| | | | 96 | 97 | 98 | 99 | 100 | 101 | 102 | 103 | 104 | 105 |
| In-mold coating composition No. | | | 11 | 12 | 13 | 14 | 15 | 16 | 17 | 18 | 19 | 20 |
| Solid content concentration | | | 99 | 99 | 99 | 99 | 99 | 99 | 99 | 99 | 99 | 99 |
| (mass %) | | | | | | | | | | | | |
| Evaluation | In-mold | In-mold coated | M1- | M1- | M1- | M1- | M1- | M1- | M1- | M1- | M1- | M1- |
| | coated | molding name | 11 | 12 | 13 | 14 | 15 | 16 | 17 | 18 | 19 | 20 |
| | molding | Water-resistant | A | A | A | A | B | A | A | A | A | A |
| | (M1) | adhesion | | | | | | | | | | |
| | | Hardness | A | B | A | B | B | A | A | B | B | A |
| | | Weather | A | A | A | B | B | A | A | A | A | B |
| | | resistance | | | | | | | | | | |
| | | Pinhole | C | A | A | A | A | A | A | A | A | A |
| | | resistance | | | | | | | | | | |
| | | Mold | A | A | A | A | A | A | A | A | A | A |
| | | releasability | | | | | | | | | | |
| | In-mold | In-mold coated | M2- | M2- | M2- | M2- | M2- | M2- | M2- | M2- | M2- | M2- |
| | coated | molding name | 11 | 12 | 13 | 14 | 15 | 16 | 17 | 18 | 19 | 20 |
| | molding | Water-resistant | B | A | A | B | C | B | A | A | B | A |
| | (M2) | adhesion | | | | | | | | | | |
| | | Hardness | A | B | A | B | B | A | A | B | B | A |
| | | Weather | A | A | A | B | B | A | A | A | A | B |
| | | resistance | | | | | | | | | | |
| | | Pinhole | C | A | A | A | A | A | A | A | A | A |
| | | resistance | | | | | | | | | | |
| | | Mold | A | A | A | A | A | A | A | A | A | A |
| | | releasability | | | | | | | | | | |

TABLE 4-2

| | | | Example | | | | | | | | | |
|---|---|---|---|---|---|---|---|---|---|---|---|---|
| | | | 106 | 107 | 108 | 109 | 110 | 111 | 112 | 113 | 114 | 115 |
| In-mold coating composition No. | | | 21 | 22 | 23 | 24 | 25 | 26 | 27 | 28 | 29 | 30 |
| Solid content concentration (mass %) | | | 99 | 99 | 99 | 99 | 99 | 99 | 99 | 99 | 99 | 99 |
| Evaluation | In-mold | In-mold coated | M1- | M1- | M1- | M1- | M1- | M1- | M1- | M1- | M1- | M1- |
| | coated | molding name | 21 | 22 | 23 | 24 | 25 | 26 | 27 | 28 | 29 | 30 |
| | molding | Water-resistant | A | A | B | A | A | C | C | A | A | A |
| | (M1) | adhesion | | | | | | | | | | |
| | | Hardness | A | A | A | A | A | A | A | A | A | A |
| | | Weather resistance | A | B | C | A | A | C | A | A | A | A |
| | | Pinhole resistance | A | C | D | B | D | A | D | D | C | A |
| | | Mold releasability | A | A | A | A | A | A | A | A | A | A |
| | In-mold | In-mold coated | M2- | M2- | M2- | M2- | M2- | M2- | M2- | M2- | M2- | M2- |
| | coated | molding name | 21 | 22 | 23 | 24 | 25 | 26 | 27 | 28 | 29 | 30 |
| | molding | Water-resistant | A | B | C | A | A | C | C | A | A | A |
| | (M2) | adhesion | | | | | | | | | | |
| | | Hardness | A | A | A | A | A | A | A | A | A | A |
| | | Weather resistance | A | B | C | A | A | C | A | A | A | A |
| | | Pinhole resistance | A | C | D | B | D | A | D | D | C | A |
| | | Mold releasability | A | A | A | A | A | A | A | A | A | A |
| | | | Example | | | | | Comparative Example | | | | |
| | | | 116 | 117 | 118 | 119 | 120 | 16 | 17 | 18 | 19 | 20 |
| In-mold coating composition No. | | | 31 | 32 | 33 | 34 | 35 | 36 | 37 | 38 | 39 | 40 |
| Solid content concentration (mass %) | | | 99 | 99 | 95 | 90 | 99 | 99 | 99 | 85 | 99 | 99 |
| Evaluation | In-mold | In-mold coated | M1- | M1- | M1- | M1- | M1- | M1- | M1- | M1- | M1- | M1- |
| | coated | molding name | 31 | 32 | 33 | 34 | 35 | 36 | 37 | 38 | 39 | 40 |
| | molding | Water-resistant | A | A | A | A | A | D | E | A | E | E |
| | (M1) | adhesion | | | | | | | | | | |
| | | Hardness | A | A | A | A | C | A | E | A | E | E |
| | | Weather resistance | C | A | A | A | C | A | E | A | E | E |
| | | Pinhole resistance | A | D | A | A | A | A | E | A | E | E |
| | | Mold releasability | A | A | B | C | A | A | E | E | E | E |
| | In-mold | In-mold coated | M2- | M2- | M2- | M2- | M2- | M2- | M2- | M2- | M2- | M2- |
| | coated | molding name | 31 | 32 | 33 | 34 | 35 | 36 | 37 | 38 | 39 | 40 |
| | molding | Water-resistant | A | A | A | A | A | E | E | A | E | E |
| | (M2) | adhesion | | | | | | | | | | |
| | | Hardness | A | A | A | A | C | A | E | A | E | E |
| | | Weather resistance | C | A | A | A | C | A | E | A | E | E |
| | | Pinhole resistance | A | D | A | A | A | A | E | A | E | E |
| | | Mold releasability | A | A | B | C | A | A | E | E | E | E |

1. A coating composition, comprising (A) an isocyanate-reactive group-containing compound, (B) a polyisocyanate compound, and (C) a carbodiimide group-containing compound and having a solid content concentration of 90 mass % or greater.

2. The coating composition according to claim 1, wherein the carbodiimide group-containing compound (C) has an isocyanate group.

3. The coating composition according to claim 1, wherein the carbodiimide group-containing compound (C) has an aromatic ring structure.

4. The coating composition according to claim 1, wherein a number average molecular weight of the carbodiimide group-containing compound (C) is within a range of 500 to 5000.

5. An in-mold coating method comprising a step of injecting an in-mold coating composition between a molded substrate and an inner wall of mold, curing the in-mold coating composition, and then removing a coated molding from the mold, wherein the in-mold coating composition is the coating composition according to claim 1.

6. The in-mold coating method according to claim 5, wherein the in-mold coating composition further comprises an internal release agent (D).

7. The in-mold coating method according to claim 6, wherein the internal release agent (D) comprises a fatty acid amide.
